(19) United States
(12) Patent Application Publication
(10) Pub. No.: US 2025/0324434 A1
(43) Pub. Date: Oct. 16, 2025

(54) PHYSICAL DOWNLINK SHARED CHANNEL RESOURCES THAT CARRY DOWNLINK CONTROL INFORMATION FOR MULTIPLE USER EQUIPMENTS

(71) Applicant: QUALCOMM Incorporated, San Diego, CA (US)

(72) Inventors: Morteza SOLTANI, San Diego, CA (US); Jing SUN, San Diego, CA (US); Chih-Hao LIU, San Diego, CA (US)

(21) Appl. No.: 18/635,420

(22) Filed: Apr. 15, 2024

(51) Int. Cl. H04W 72/232; H04L 1/00; H04W 72/04

(52) U.S. Cl. CPC H04W 72/232; H04L 1/0061; H04W 72/04

(57) ABSTRACT

Various aspects of the present disclosure generally relate to wireless communication. In some aspects, a first user equipment (UE) may receive, from a network node, first downlink control information (DCI) via a physical downlink control channel (PDCCH), the first DCI comprising control information for a plurality of UEs and indicating resources of a physical downlink shared channel (PDSCH) that carry second DCI without carrying a downlink shared channel, and then may receive the second DCI that comprises control information for one or more UEs from the plurality of UEs. The first UE may receive an indication of the one or more UEs that have control information in the second DCI and may determine whether to attempt to decode the second DCI based on whether the one or more UEs that have the control information in the second DCI comprise the first UE. Numerous other aspects are described.

### FIELD OF THE DISCLOSURE

Aspects of the present disclosure generally relate to wireless communication and specifically relate to techniques, apparatuses, and methods for physical downlink shared channel resources that carry downlink control information for multiple user equipments.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a first user equipment (UE) includes receiving, from a network node, first downlink control information (DCI) via a physical downlink control channel (PDCCH), the first DCI comprising control information for a plurality of UEs and indicating resources of a physical downlink shared channel (PDSCH) that carry second DCI without carrying a downlink shared channel; receiving, via the resources of the PDSCH, the second DCI from the network node, the second DCI comprising control information for one or more UEs from the plurality of UEs; receiving, from the network node, an indication of the one or more UEs that have control information in the second DCI; and determining whether to attempt to decode at least a portion of the second DCI based at least in part on whether the one or more UEs that have the control information in the second DCI comprise the first UE.

In some aspects, a method of wireless communication performed by a network node includes transmitting, to a plurality of UEs, first DCI via a PDCCH, the first DCI comprising control information for the plurality of UEs and indicating resources of a PDSCH that carry second DCI without carrying a downlink shared channel;
transmitting, via the resources of the PDSCH and to one or more UEs from the plurality of UEs, the second DCI comprising control information for the one or more UEs from the plurality of UEs; and transmitting, to the plurality of UEs, an indication of the one or more UEs that have control information in the second DCI.

In some aspects, an apparatus for wireless communication at a first UE includes one or more memories, and one or more processors coupled with the one or more memories and configured to cause the first UE to: receive, from a network node, first DCI via a PDCCH, the first DCI comprising control information for a plurality of UEs and indicating resources of a PDSCH that carry second DCI without carrying a downlink shared channel; receive, via the resources of the PDSCH, the second DCI from the network node, the second DCI comprising control information for one or more UEs from the plurality of UEs; receive, from the network node, an indication of the one or more UEs that have control information in the second DCI; and determine whether to attempt to decode at least a portion of the second DCI based at least in part on whether the one or more UEs that have the control information in the second DCI comprise the first UE.

In some aspects, an apparatus for wireless communication at a network node includes one or more memories, and one or more processors coupled with the one or more memories and configured to cause the network node to: transmit, to a plurality of UEs, first DCI via a PDCCH, the first DCI comprising control information for the plurality of UEs and indicating resources of a PDSCH that carry second DCI without carrying a downlink shared channel; transmit, via the resources of the PDSCH and to one or more UEs from the plurality of UEs, the second DCI comprising control information for the one or more UEs from the plurality of UEs; and transmit, to the plurality of UEs, an indication of the one or more UEs that have control information in the second DCI.

In some aspects, a non-transitory computer-readable medium storing a set of instructions for wireless communication includes one or more instructions that, when executed by one or more processors of a first UE, cause the first UE to: receive, from a network node, first DCI via a PDCCH, the first DCI comprising control information for a plurality of UEs and indicating resources of a PDSCH that carry second DCI without carrying a downlink shared channel; receive, via the resources of the PDSCH, the second DCI from the network node, the second DCI comprising control information for one or more UEs from the plurality of UEs; receive, from the network node, an indication of the one or more UEs that have control information in the second DCI; and determine whether to attempt to decode at least a portion of the second DCI based at least in part on whether the one or more UEs that have the control information in the second DCI comprise the first UE.

In some aspects, a non-transitory computer-readable medium storing a set of instructions for wireless communication includes one or more instructions that, when executed by one or more processors of a network node, cause the network node to: transmit, to a plurality of UEs, first DCI via a PDCCH, the first DCI comprising control information for the plurality of UEs and indicating resources of a PDSCH that carry second DCI without carrying a downlink shared channel; transmit, via the resources of the PDSCH and to one or more UEs from the plurality of UEs, the second DCI comprising control information for the one or more UEs from the plurality of UEs; and transmit, to the plurality of UEs, an indication of the one or more UEs that have control information in the second DCI.

In some aspects, an apparatus for wireless communication includes means for receiving, from a network node, first DCI via a PDCCH, the first DCI comprising control information for a plurality of UEs and indicating resources of a PDSCH that carry second DCI without carrying a downlink shared channel; means for receiving, via the resources of the PDSCH, the second DCI from the network node, the second DCI comprising control information for one or more UEs from the plurality of UEs; means for receiving, from the network node, an indication of the one or more UEs that have control information in the second DCI; and means for determining whether to attempt to decode at least a portion of the second DCI based at least in part on whether the one or more UEs that have the control information in the second DCI comprise the first UE.

In some aspects, an apparatus for wireless communication includes means for transmitting, to a plurality of UEs, first DCI via a PDCCH, the first DCI comprising control information for the plurality of UEs and indicating resources of a PDSCH that carry second DCI without carrying a downlink shared channel; means for transmitting, via the resources of the PDSCH and to one or more UEs from the plurality of UEs, the second DCI comprising control information for the one or more UEs from the plurality of UEs; and means for transmitting, to the plurality of UEs, an indication of the one or more UEs that have control information in the second DCI.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a wireless communication network, in accordance with the present disclosure.

FIGS. 5-11 are diagrams illustrating examples of processes that support physical downlink shared channel (PDSCH) resources carrying downlink control information (DCI) for multiple UEs, in accordance with the present disclosure.

FIG. 12 is a diagram illustrating an example of signaling exchanged between a network node and UE, in accordance with the present disclosure.

FIG. 13 is a diagram illustrating an example process performed, for example, at a UE or an apparatus of a UE, in accordance with the present disclosure.

FIG. 14 is a diagram illustrating an example process performed, for example, at a network node or an apparatus of a network node, in accordance with the present disclosure.

FIGS. 15 and 16 are diagrams of example apparatuses for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Some wireless communication devices (e.g., a network node, a user equipment (UE)) may rely on downlink control information (DCI) to coordinate communications between devices. For example, a network node may transmit DCI to a UE for downlink grants, uplink grants, or some other reason. In some wireless communication networks, a network node may transmit DCI over a physical downlink control channel (PDCCH). In this example, the DCI may be delivered via a control resource set (CORESET), and the UE may perform a blind decoding of multiple decoding candidates within the CORESET to identify the DCI that includes control information for the UE. In some instances, the blind decoding candidates may be organized in search space sets, and one or more search space sets may be associated with one CORESET. Relying on blind decoding for communicating DCI via a PDCCH may reduce a blocking between UEs by randomly hashing locations of PDCCH from different UEs differently in a CORESET. But the blind decoding increases a processing burden at the UE, thus increasing a complexity at the UE for receiving and decoding DCI (e.g., as compared to DCI communications that do not rely on blind decoding).

Accordingly, some network nodes may offload at least a portion of the control information (e.g., DCI) for a UE from PDCCH resources, to instead transmit the control information via PDSCH resources. That is, the network node may transmit at least the portion of the control information for the UE via PDSCH resources. In some cases, this technique may be referred to as “DCI piggybacked on PDSCH.” To offload control from PDCCH resources, the network node may attempt to decrease a size of the DCI transmission communicated via the PDCCH resources, and may utilize the PDCCH resources for other UEs (e.g., such as for UEs that do not have a downlink grant). In some cases, the network node may transmit variable lengths of control information via PDSCH resources, which may enable the network node to align a size of control information transmitted via PDCCH resource portions across multiple formats, which may in turn reduce a blind decoding complexity at the UE.

Transmitting at least a portion of the DCI via PDSCH resources may reduce an amount of blind decoding (e.g., of the PDCCH) that a UE performs to decode DCI. Additionally, control information (e.g., DCI) may be more efficiently communicated via PDSCH resources as compared to PDCCH resources. That is, there may be reduced overhead associated with communications via PDSCH resources. For example, there may be less cyclic redundancy check (CRC) overhead associated with communications transmitted via PDSCH resources (e.g., due to a CRC length reduction in PDSCH transmissions). In some instances, the decrease in CRC length reduction may additionally decrease an amount of pruning performed by the UE to decode the DCI. In another example, PDSCH transmissions may rely on a shared demodulation reference signal (DMRS) (e.g., for a data DMRS) while PDCCH transmissions may rely on a DMRS that is not shared.

Additionally, PDSCH transmissions may be associated with greater beamforming and rank efficiency as compared to PDCCH transmissions. Thus, if a network node transmits control information via PDSCH resources and using a data rate that is similar to a data rate used for data channel transmissions via the PDSCH, the control information may be transmitted with a higher efficiency as compared to transmissions of the control information via PDCCH resources. Additionally, the network node may decrease a transmission rate for control information transmissions via PDSCH resources (e.g., as compared to a transmission rate for data via PDSCH resources) to improve a reliability of the control information transmissions while still transmitting the control information via a greater transmission rate than for transmissions via PDCCH resources.

In some instances of offloading at least a portion of the control information to PDSCH resources, a network node may determine to transmit DCI via the PDSCH resources without transmitting any downlink shared channel transmissions (e.g., PDSCH data) via the PDSCH resources. For example, in cases where a size of control information to be transmitted via the PDSCH resources causes there to not be enough space for the PDSCH data to also be transmitted via the PDSCH resources, the network node may transmit a DCI-only transmission via the PDSCH resources (e.g., and may not transmit any downlink shared channel transmissions via the PDSCH resources). Additionally, or alternatively, a PDSCH payload size may not account for a payload size of the DCI, and a resulting impact to PDSCH decoding may be unnecessarily high. Therefore, the network node may elect to transmit, via the resources of the PDSCH, DCI without also including any downlink shared channel transmissions in the resources of the PDSCH. That is, the network node may transmit a DCI-only transmission via the PDSCH resources.

If the network node transmits a DCI-only transmission via the PDSCH resources via a unicast mode (e.g., to one UE), the DCI-only transmission in the PDSCH resources may include UE-specific control information for that one UE. The UE may perform a blind decoding of a unicast DCI received via PDCCH resources based on an identifier of the UE (e.g., a cell radio network temporary identifier (C-RNTI) of the UE) and the unicast DCI received via the PDSCH resources may not include a UE identifier.

In some other examples, the network node may transmit a DCI-only transmission via the PDSCH resources via a multicast or groupcast mode (e.g., to more than UE). Here, DCI transmitted via the PDCCH resources may include control information for a group of UEs (e.g., group-specific control information), and accordingly the network node may address the group of UEs in the control information transmitted via the PDCCH resources. Then, the DCI transmitted via the PDSCH resources may include UE-specific control information for one or more UEs from the group. That is, the network node may send multiple grants (e.g., downlink grants, uplink grants) to the one or more UEs in the DCI transmitted via the PDSCH resources.

Various aspects relate generally a network node transmitting, in a broadcast or multicast mode, control information via the resources associated with the PDSCH without transmitting downlink shared channel information (e.g., data, downlink shared channel transport blocks) via the resources associated with the PDSCH. Some aspects more specifically relate to the encoding and decoding operations associated with the control information transmitted via the PDCCH resources and the control information transmitted via the PDSCH resources. For example, the network node may encode the control information transmitted via the PDCCH resources using an identifier that is associated with a group of UEs. Accordingly, the group of UEs that receive the control information via the PDCCH resources may decode the control information.

Additionally, the network node may configure the group of UEs to enable each UE, of the group of UEs, to identify and decode a portion of the DCI carried via the PDSCH resources that includes control information for that UE. Accordingly, the network node may transmit, and the group of UEs may receive, DCI via PDSCH resources that are carrying DCI without carrying a downlink shared channel.

Various other aspects relate more specifically to instances where one or more of the UEs that receive the DCI via the PDCCH resources do not receive any control information via the PDSCH resources. For example, the network node may transmit the DCI, via the PDCCH resources, that includes group-specific control information for a group of UEs, and may transmit the DCI, via the PDSCH resources, that includes UE-specific control information for one or more first UEs in the group of UEs and does not include UE-specific control information for one or more second UEs in the group of UEs. In this example, the network node may transmit, and the UEs may receive, signaling indicating the one or more first UEs that have control information in the DCI carried by the PDSCH resources. Then, each UE from the group of UEs may determine whether to attempt to decode at least a portion of the DCI received via the PDSCH resources based on whether that UE was indicated as having control information in the DCI received via the PDSCH resources (e.g., based on whether that UE is one of the one or more first UEs).

Particular aspects of the subject matter described in this disclosure can be implemented to realize one or more of the following potential advantages. In some cases, by enabling each UE, in a group of UEs, to identify and decode a portion of the DCI carried via the PDSCH resources that includes control information for that UE, the network node and UE may more efficiently utilize resources for transmitting control information (e.g., as compared to cases where the network node transmits all control information via the PDCCH). Additionally, by indicating, to the group of UEs, the one or more UEs that have control information in the DCI transmitted via the PDSCH resources, the UEs may each refrain from attempting to decode DCI transmissions that do not include control information for that UE, which may decrease a power consumption at the UE.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (cMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

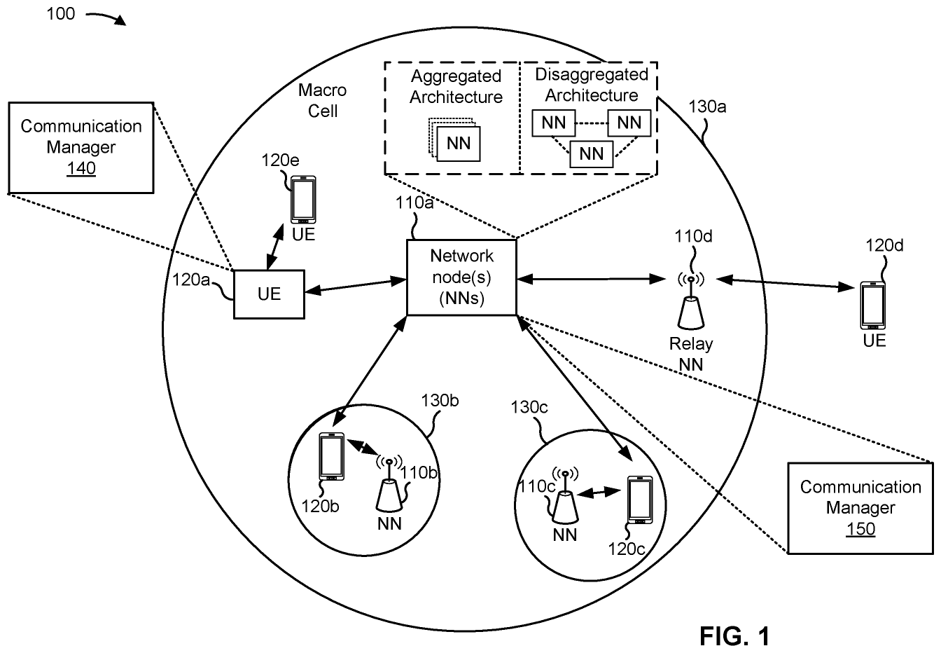

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (IFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (MTC), UEs, further enhanced cMTC (feMTC) UEs, or enhanced feMTC (efeMTC) UEs, or further evolutions thereof, all of which may be simply referred to as “MTC UEs”). An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (cMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V21) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive, from a network node, first DCI via a PDCCH, the first DCI comprising control information for a plurality of UEs and indicating resources of a PDSCH that carry second DCI without carrying a downlink shared channel; receive, via the resources of the PDSCH, the second DCI from the network node, the second DCI comprising control information for one or more UEs from the plurality of UEs; receive, from the network node, an indication of the one or more UEs that have control information in the second DCI; and determine whether to attempt to decode at least a portion of the second DCI based at least in part on whether the one or more UEs that have the control information in the second DCI comprise the first UE. Additionally, or alternatively, the communication manager 140 may perform one or more other operations described herein.

In some aspects, the network node 110 may include a communication manager 150. As described in more detail elsewhere herein, the communication manager 150 may transmit, to a plurality of UEs, first DCI via a PDCCH, the first DCI comprising control information for the plurality of UEs and indicating resources of a PDSCH that carry second DCI without carrying a downlink shared channel; transmit, via the resources of the PDSCH and to one or more UEs from the plurality of UEs, the second DCI comprising control information for the one or more UEs from the plurality of UEs; and transmit, to the plurality of UEs, an indication of the one or more UEs that have control information in the second DCI. Additionally, or alternatively, the communication manager 150 may perform one or more other operations described herein.

As indicated above, FIG. 1 is provided as an example. Other examples may differ from what is described with regard to FIG. 1.

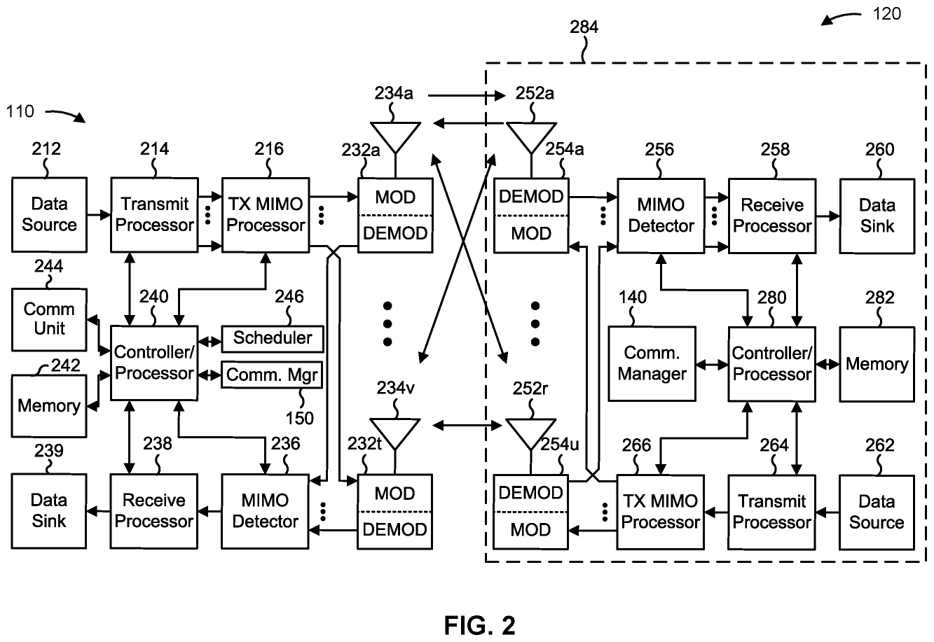

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or cyclic prefix OFDM (CP-OFDM)). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

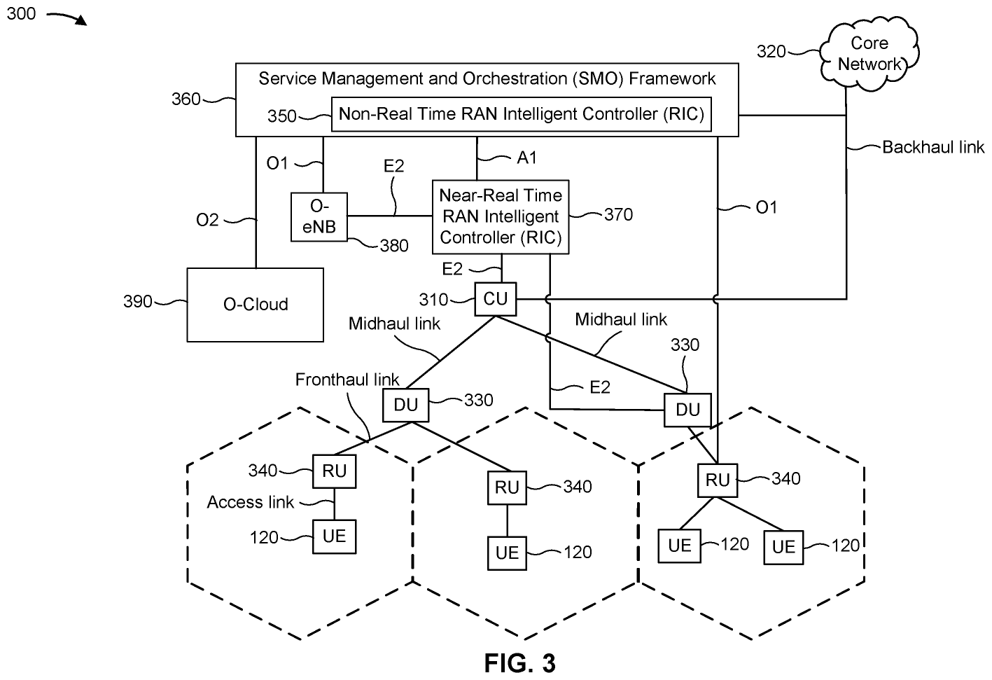

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an 02 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-CNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

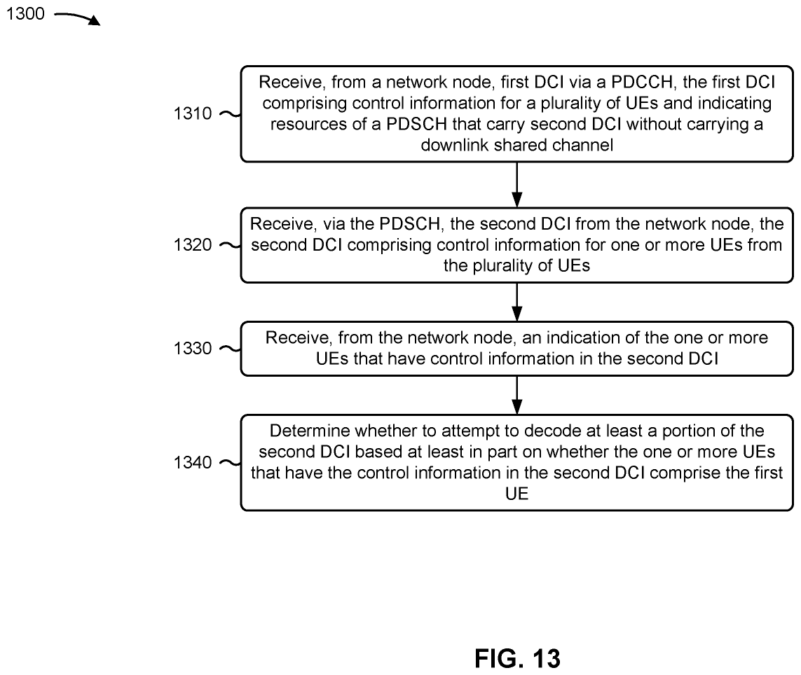

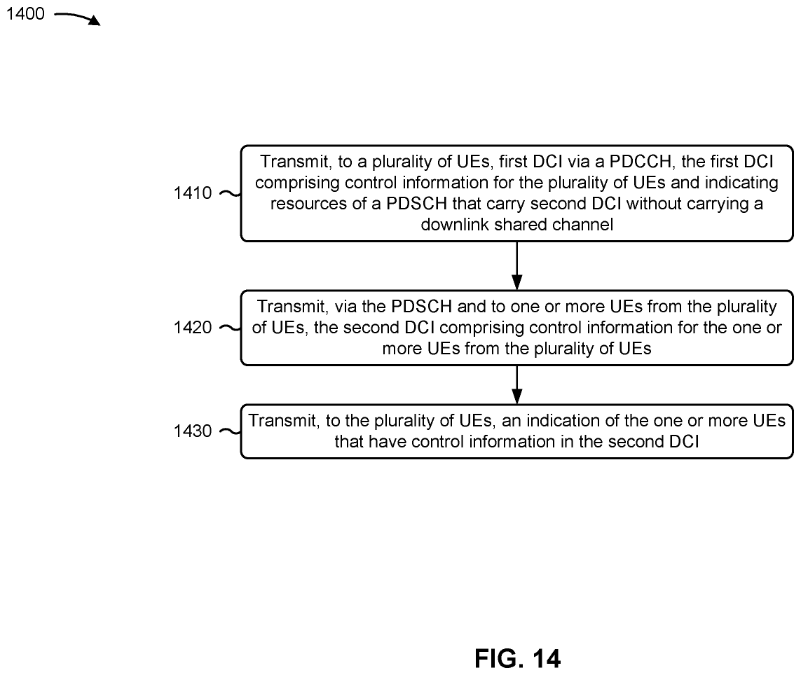

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with PDSCH resources that carry DCI for multiple UEs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1300 of FIG. 13, process 1400 of FIG. 14, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1300 of FIG. 13, process 1400 of FIG. 14, or other processes as described herein. In some examples, executing instructions may include running the instructions, converting the instructions, compiling the instructions, and/or interpreting the instructions, among other examples.

In some aspects, a first UE (e.g., the UE 120) includes means for receiving, from a network node, first DCI via a PDCCH, the first DCI comprising control information for a plurality of UEs and indicating resources of a PDSCH that carry second DCI without carrying a downlink shared channel; means for receiving, via the resources of the PDSCH, the second DCI from the network node, the second DCI comprising control information for one or more UEs from the plurality of UEs; means for receiving, from the network node, an indication of the one or more UEs that have control information in the second DCI; and/or means for determining whether to attempt to decode at least a portion of the second DCI based at least in part on whether the one or more UEs that have the control information in the second DCI comprise the first UE. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for transmitting, to a plurality of UEs, first DCI via a PDCCH, the first DCI comprising control information for the plurality of UEs and indicating resources of a PDSCH that carry second DCI without carrying a downlink shared channel; means for transmitting, via the resources of the PDSCH and to one or more UEs from the plurality of UEs, the second DCI comprising control information for the one or more UEs from the plurality of UEs; and/or means for transmitting, to the plurality of UEs, an indication of the one or more UEs that have control information in the second DCI. The means for the network node to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

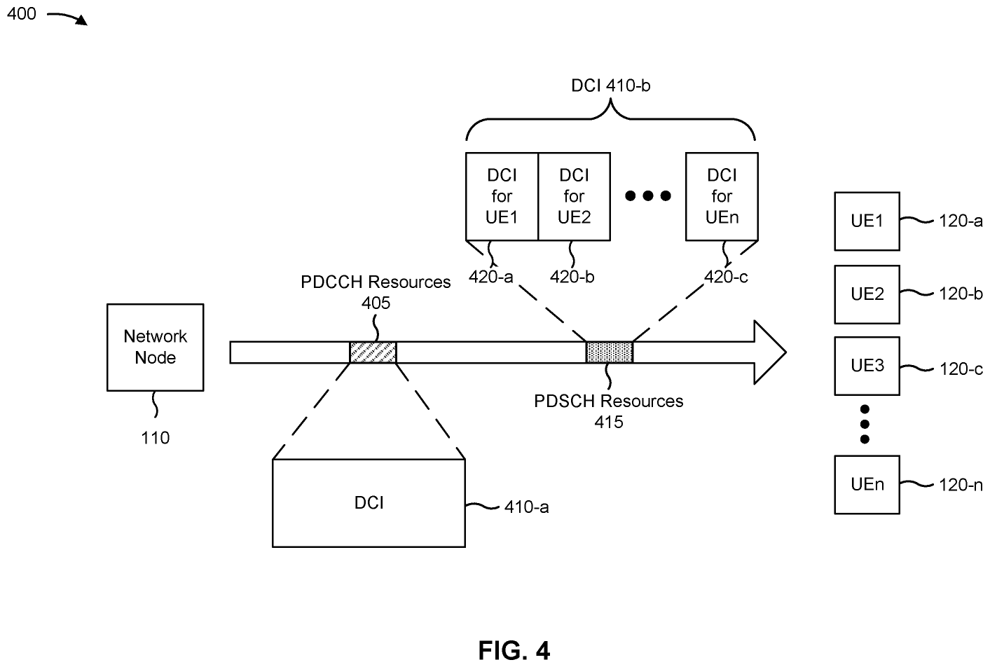

FIG. 4 is a diagram illustrating an example 400 of wireless communication network, in accordance with the present disclosure. As shown in FIG. 4, a network node 110 and UEs 120-a, 120-b, 120-c, and 120-n may communicate with one another.

In the example 400, the network node 110 may transmit DCI 410-a to the UEs 120 via PDCCH resources 405. Further, the network node 110 may transmit additional DCI 410-b to the UEs 120 via PDSCH resources 415. In some cases, when the network node 110 delivers the DCI 410 to the UEs 120 via two parts (e.g., a first part delivered to the UEs 120 in the DCI 410-a via the PDCCH resources 405 and a second part delivered to the UEs 120 in the DCI 410-b via the PDSCH resources 415), the first part of the DCI 410-a that is delivered via the PDCCH resources 405 may be referred to as DCI1 and the second part of the DCI 410-b that is delivered via the PDSCH resources 415 may be referred to as DCI2. The network node 110 may transmit a first subset of the control information for the UEs 120 via the PDCCH resources 405 (e.g., the DCI1, the DCI 410-a) and may transmit a second subset of the control information for the UEs 120 via the PDSCH resources 415 (e.g., the DCI2, the DCI 410-b).

In the DCI 410-a, the network node 110 may transmit control information to a group of UEs 120 (e.g., a plurality of UEs 120) including, for example, UE 120-a, UE 120-b, UE 120-c, and UE 120-n (and one or more additional UEs 120). For example, the DCI 410-a may be transmitted via the PDCCH resources 405 via a broadcast, groupcast, or multicast transmission. That is, the network node 110 may be operating in a broadcast, groupcast, or multicast mode when transmitting the DCI 410-a. Thus, the DCI 410-a may include control information for all of the UEs 120 in the group of UEs 120.

The DCI 410-a may be associated with a search space set and CORESET that is decoded by each UE 120 in the group of UEs 120 (e.g., UE 120-a, UE 120-b, UE 120-c, UE 120-n, and one or more additional UEs 120). In some instances, to ensure that each of the UEs 120 in the group of UEs 120 may decode the DCI 410, an identifier associated with the DCI 410 may be shared by the group of UEs 120. For example, the DCI 410-a may include a shared radio network temporary identifier (RNTI), such as a system information RNTI (SI-RNTI) or a paging RNTI (P-RNTI). Additionally, a format of the DCI 410-a and the search space for the DCI 410-a may be shared by each of the UEs 120 in the group of UEs 120. In particular, the network node 110 may configure a group common search space associated with the DCI 410-a that is shared by each of the UEs 120 in the group of UEs 120.

The DCI 410-a may include basic information about the PDSCH resources 415, including a resource allocation associated with the PDSCH resources 415, a rank associated with the PDSCH resources 415, and a modulation order associated with the PDSCH resources 415. In some cases, the information about the PDSCH resources 415 included in the DCI 410-a may enable the UEs 120 to perform DMRS-based channel estimation and to perform a demodulation of transmissions received via the PDSCH resources 415.

The network node 110 may additionally include, in the DCI 410-a, a field with information about the DCI 410-b that is transmitted via the PDSCH resources 415. For example, the DCI 410-a may include a size field that includes information related to a size (e.g., a quantity of resource elements) of the DCI 410-b. Additionally, or alternatively, the size field may include information about a code rate (e.g., a payload size) of the DCI 410-b. The DCI 410-a may additionally include information indicating a time domain resource allocation (TDRA) and/or frequency domain resource allocation (FDRA) of the DCI 410-b, a rank of the DCI 410-b, or other information related to the DCI 410-b that is to be transmitted via the PDSCH resources 415. In some instances, the information related to the DCI 410-b that is included in the DCI 410-a may indicate rate control information associated with the DCI 410-b.

In the DCI 410-b, the network node 110 may transmit a remaining portion of the DCI for the UEs 120. In some cases, the DCI 410-b may include UE-specific control information for a subset of the UEs 120 in the group of UEs 120 (e.g., for one or more UEs of the plurality of UEs 120 that receive the DCI 410-a). For example, the DCI 410-b may include multiple sets of control information that include UE-specific control information. In the example 400, the DCI 410-b may include a first set of control information for the UE 120-a (e.g., the DCI for UE1 420-a), a second set of control information for the UE 120-b (e.g., the DCI for UE2 420-b), and a third set of control information for the UE 120-n (e.g., the DCI for UEn 420-c).

The DCI 410-b may include the sets of control information that are jointly encoded or separately encoded. For example, the DCI 410-b may include a shared CRC, and the network node 110 may jointly encode the sets of control information (e.g., the DCI for UE1 420-a, the DCI for UE2 420-b, and the DCI for UEn 420-c) using, for example, a polar code and/or a low-density parity check (LDPC) with the shared CRC. In another example, the DCI 410-b may include a CRC for each UE 120 with control information in the DCI 410-b. For example, the DCI 410-b may include a first CRC associated with the UE 120-a, a second CRC associated with the UE 120-b, and a third CRC associated with the UE 120-n. Here, the network node 110 may separately encode the sets of control information (e.g., the DCI for UE1 420-a, the DCI for UE2 420-b, and the DCI for UEn 420-c) using, for example, a polar code and/or LDPC with the CRCs associated with each UE 120.

For example, the network node 110 may include information related to a downlink grant for the UEs 120 in the DCI 410-b, such as a hybrid automatic repeat request (HARQ) process identifier, a redundancy version (RV) identifier, and/or a new data indicator. The DCI 410-b may additionally include other non-time-critical information, such as transmit power control (TPC) information, CSI triggering information, SRS triggering information, a downlink assignment index (DAI), an uplink grant (e.g., including an FDD uplink grant or a TDD with the uplink grant for a later slot), or other downlink grants (e.g., downlink grants for later slots, downlink grants for multi-transmission time interval (multi-TTI) or multi-slot grants).

In the example 400, the network node 110 may transmit the DCI 410-b via each of the PDSCH resources 415, and may not include any downlink shared channel in the PDSCH resources 415. That is, all of the PDSCH resources 415 may carry DCI 410-b, and there may not be any remaining PDSCH resources 415 for carrying the downlink shared channel. Thus, in the example 400, the PDSCH resources 415 may carry the DCI 410-b without carrying the downlink shared channel.

To ensure that each of the UEs 120 that have control information in the DCI 410-b are able to decode at least the portion of the DCI 410-b that includes control information for that respective UE 120, the network node 110 may configure the UEs 120 to enable each UE 120 having control information in the DCI 410-b to identify and decode a portion of the DCI 410-b carried via the PDSCH resources 415 that includes control information for that UE 120. Accordingly, the network node 110 may transmit, and the group of UEs 120 may receive, the DCI 410-b via PDSCH resources 415 that are carrying the DCI 410-b without carrying a downlink shared channel.

Additionally, the network node 110 may transmit, and the UEs 120 may receive, signaling indicating the one or more UEs 120 that have control information in the DCI 410-b carried by the PDSCH resources 415. Then, each UE 120 from the group of UEs 120 may determine whether to attempt to decode at least a portion of the DCI 410-b based on whether that UE 120 was indicated as having control information in the DCI 410-b. In the example 400, the network node 110 may transmit signaling indicating that UEs 120-a, 120-b, and 120-n have control information in at least a portion of the DCI 410-b. Accordingly, the UEs 120-a, 120-b, and 120-n may attempt to decode at least the portions of the DCI 410-b including the control information for that UE 120 (e.g., the DCI for UE1 420-a, the DCI for UE2 420-b, and the DCI for UEn 420-c, respectively) based on the signaling indicating that the DCI 410-b includes control information for the UEs 120-a, 120-b, and 120-n. Additionally, the UE 120-c may refrain from attempting to decode at least a portion of the DCI 410-b based on the signaling indicating that the DCI 410-b includes control information for UEs 120-a, 120-b, and 120-n not indicating that the DCI 410-b includes control information for UE 120-c.

As indicated above, FIG. 4 is provided as an example. Other examples may differ from what is described with respect to FIG. 4.

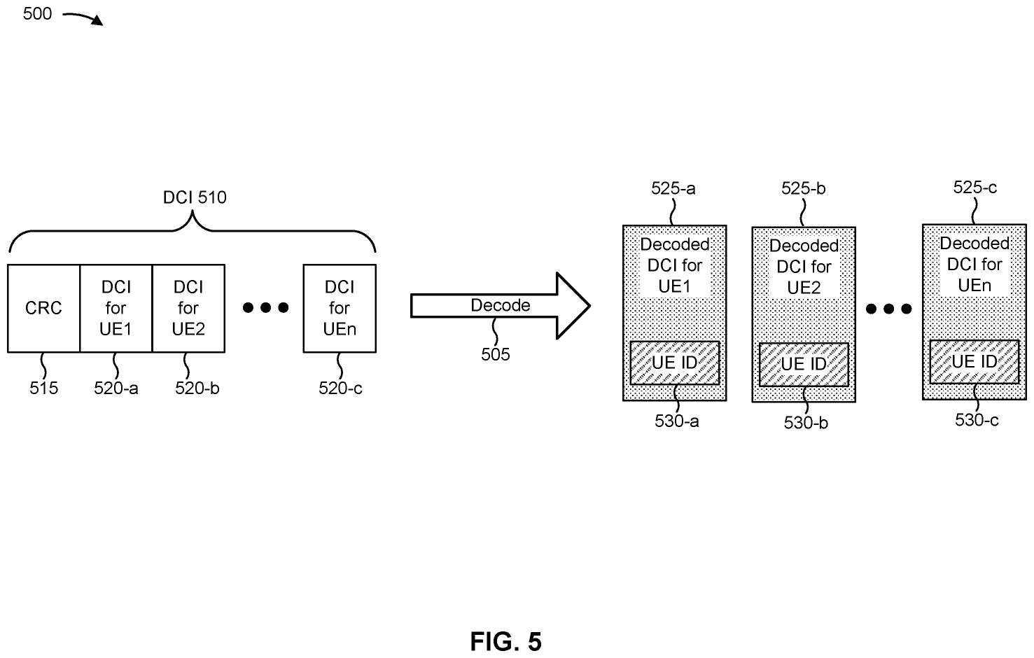

FIG. 5 is a diagram illustrating an example 500 of a process that supports PDSCH resources carrying DCI for multiple UEs, in accordance with the present disclosure. In some cases, the example 500 may include aspects of the example 400 described with respect to FIG. 4. For example, the DCI 510 may include aspects of the DCI 410-b. That is, a network node may transmit the DCI 510 to a group of UEs via a set of PDSCH resources (e.g., that do not carry a downlink shared channel).

The DCI 510 may correspond to DCI2, and may include one or more sets of control information that are UE-specific. For example, the DCI 510 may include a first set of control information that is for the UE1 (e.g., the DCI for UE1 520-a), a second set of control information that is for the UE2 (e.g., the DCI for UE2 520-b), and a third set of control information that is for the UEn (e.g., the DCI for UEn 520-c). A network node may encode the DCI 510 to ensure that each of the UEs having control information in the DCI 510 may be capable of decoding at least a portion of the DCI 510 that includes the control information for that UE.

In the example 500, the network node may encode the DCI 510 (e.g., the entire content of the DCI 510) as one codeword and attach a single CRC 515. For example, the network node may encode the DCI 510 via a polar code or an LDPC. The network node 110 may scramble the CRC 515 by an identifier that is common to the group of UEs (e.g., including the UE1, UE2, and UEn). For example, the network node 110 may scramble the CRC 515 by a broadcast or multicast RNTI (e.g., an SI-RNTI, a P-RNTI).

The network node may include a UE-specific identifier (e.g., the UE IDs 530) within the payload of the DCI for each UE 520. For example, the DCI for UE1 520-a may include, in the payload, the UE ID 530-a; the DCI for UE2 520-b may include, in the payload, the UE ID 530-b; and the DCI for UEn 520-c may include, in the payload, the UE ID 530-c. The UE IDs 530 may be UE-specific identifiers such as a C-RNTI. Additionally, or alternatively, the UE IDs 530 may be other UE-specific identifiers that are shorter (e.g., that include fewer bits) than a C-RNTI, which may include up to 16 bits. For example, the UE IDs 530 may instead include a part of the C-RNTI corresponding to each UE. Here, a first portion of the C-RNTI may be included in the UE ID 530 (e.g., 8 bits of the C-RNTI) and a second portion of the C-RNTI may be included in a MAC protocol data unit (PDU) (e.g., when a grant comes with an associated PDSCH transmission). In another example, the network node may configure the UE IDs 530 for each UE in the group of UEs (e.g., the plurality of UEs that receive the groupcast/multicast/broadcast DCI via the PDCCH resources), where the configured UE ID 530 is shorter than a UE-specific C-RNTI. Here, each UE ID 530 may indicate one UE from the group of UEs.

As shown by reference number 505, a UE may decode the DCI 510. For example, a UE may decode the entire DCI 510 that is carried by the PDSCH resources to obtain the decoded DCIs for the UEs 525. That is, after decoding the entire DCI 510, each UE may obtain the decoded DCI for the UE1 525-a, the decoded DCI for UE2 525-b, and the decoded DCI for UEn 525-c. Then, each UE may identify the portion of the DCI 510 that includes control information for that UE based on the UE ID 530 that is included in each set of decoded control information (e.g., in the decoded DCI for the UEs 525). For example, the UE1 may identify the control information that is for the UE1 as the decoded DCI for UE1 525-a based on the decoded DCI for UE1 525-a including the UE ID 530-a that corresponds to the UE1.

As indicated above, FIG. 5 is provided as an example. Other examples may differ from what is described with respect to FIG. 5.

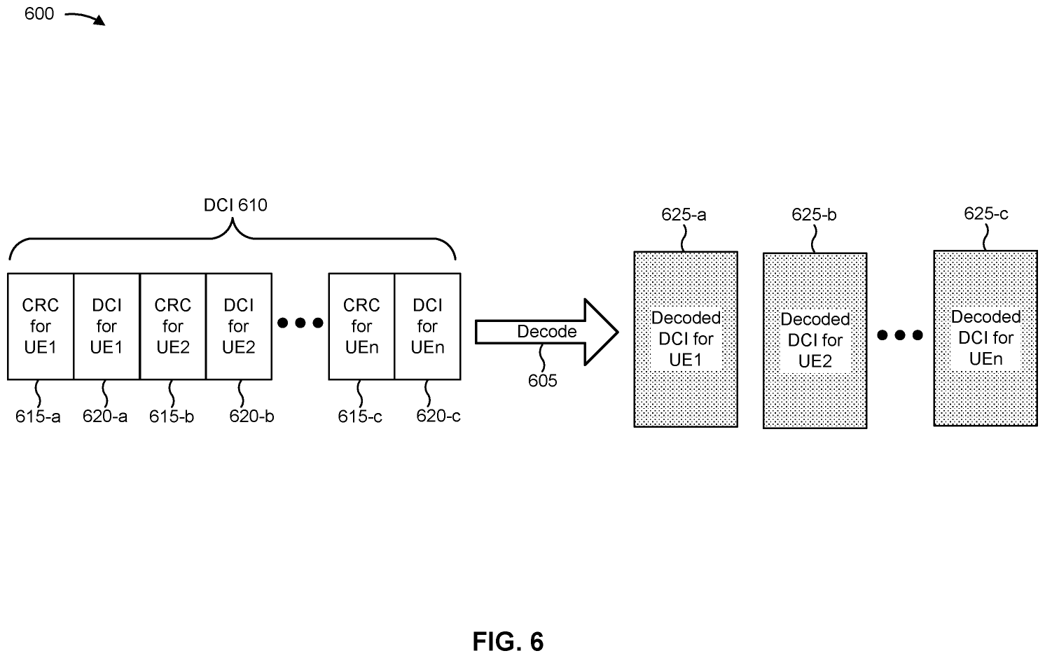

FIG. 6 is a diagram illustrating an example 600 of a process that supports PDSCH resources carrying DCI for multiple UEs, in accordance with the present disclosure. In some cases, the example 600 may include aspects of the example 400 described with respect to FIG. 4. For example, the DCI 610 may include aspects of the DCI 410-b. That is, a network node may transmit the DCI 610 to a group of UEs via a set of PDSCH resources (e.g., that do not carry a downlink shared channel).

The DCI 610 may correspond to DCI2, and may include one or more sets of control information that are UE-specific. For example, the DCI 610 may include a first set of control information that is for the UE1 (e.g., the DCI for UE1 620-a), a second set of control information that is for the UE2 (e.g., the DCI for UE2 620-b), and a third set of control information that is for the UEn (e.g., the DCI for UEn 620-c). A network node may encode the DCI 610 to ensure that each of the UEs having control information in the DCI 610 may be capable of decoding at least a portion of the DCI 610 that includes the control information for that UE.

In the example 600, the network node may encode each set of control information in the DCI 610 (e.g., each DCI for a UE 620) separately. For example, the DCI 610 may additionally include a CRC for each UE having control information in the DCI 610. That is, the DCI 610 may include CRC for UE1 615-a, CRC for UE2 615-b, and CRC for UEn for 615-c. To encode the DCI 610, the network node may encode the DCI for each UE 615 separately, with its own corresponding CRC attached.

The network node may also scramble each CRC by a UE-specific identifier of the corresponding UE. For example, the network node may encode the DCI for UE1 620-a with the CRC for UE1 615-a attached, and may scramble the CRC for UE1 615-a by a UE-specific identifier of UE1. The UE-specific identifiers may include a C-RNTI. Additionally, or alternatively, the UE-specific identifiers may be other UE-specific identifiers that are shorter (e.g., that include fewer bits) than a C-RNTI, which may include up to 16 bits. For example, the UE-specific identifiers may instead include a part of the C-RNTI corresponding to each UE. Here, a first portion of the C-RNTI may be used to scramble the CRC for each UE. In another example, the network node may configure UE-specific identifiers for each UE in the group of UEs (e.g., the plurality of UEs that receive the groupcast/multicast/broadcast DCI via the PDCCH resources), where the configured UE-specific identifiers are shorter than a UE-specific C-RNTI.

As shown by reference number 605, the UEs may decode the DCI 610 (e.g., to obtain the decoded DCI for UEs 625) and identify the portion of the DCI 610 that includes control information for that UE based on a CRC check. That is, the UEs may perform a CRC check on each CRC for UE 615, and identify the decoded DCI for UE 625 that includes control information for that UE in response to the CRC check passing (e.g., in response to successfully descrambling a CRC using a UE-specific identifier corresponding to that UE). For example, the UE2 may identify that the portion of the DCI 610 that includes control information for the UE2 is the decoded DCI for UE2 625-b in response to successfully descrambling the CRC for UE2 615-b using a UE-specific identifier of the UE2. In some cases, the DCI for each UE (e.g., the 620 and 625) May not include a UE-specific identifier for the corresponding UEs, in this example, as the UE is capable of identifying the portion of the DCI that includes control information for that UE using the CRC check (e.g., and does not rely on the control information including a UE-specific identifier).

As indicated above, FIG. 6 is provided as an example. Other examples may differ from what is described with respect to FIG. 6.

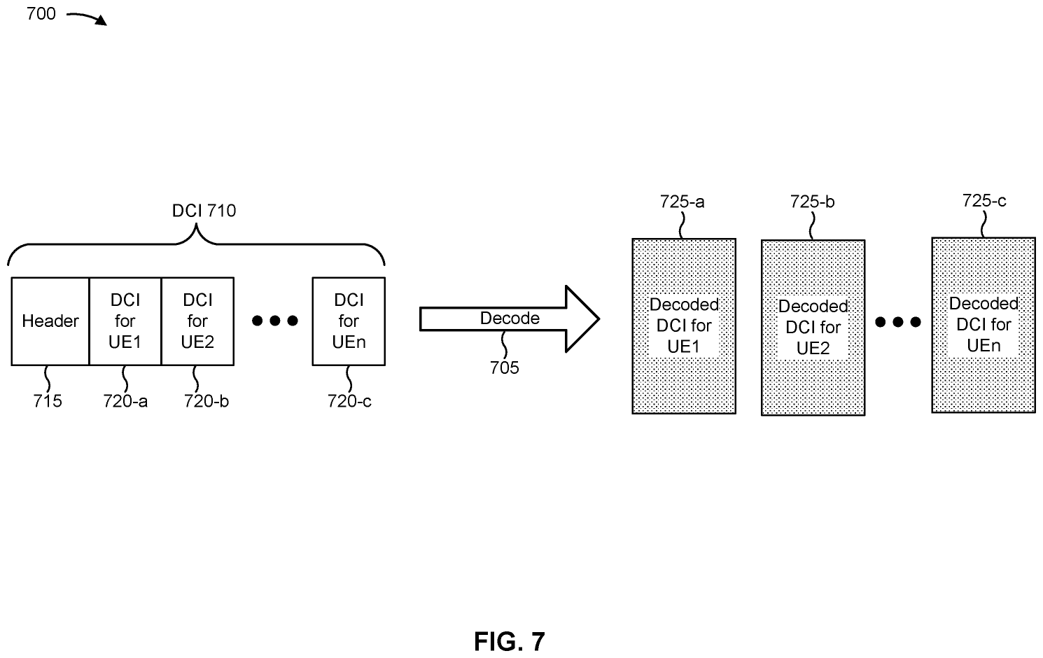

FIG. 7 is a diagram illustrating an example 700 of a process that supports PDSCH resources carrying DCI for multiple UEs, in accordance with the present disclosure. In some cases, the example 700 may include aspects of the example 400 described with respect to FIG. 4. For example, the DCI 710 may include aspects of the DCI 410-b. That is, a network node may transmit the DCI 710 to a group of UEs via a set of PDSCH resources (e.g., that do not carry a downlink shared channel).

The DCI 710 may correspond to DCI2, and may include one or more sets of control information that are UE-specific. For example, the DCI 710 may include a first set of control information that is for the UE1 (e.g., the DCI for UE1 720-a), a second set of control information that is for the UE2 (e.g., the DCI for UE2 720-b), and a third set of control information that is for the UEn (e.g., the DCI for UEn 720-c). A network node may encode the DCI 710 to ensure that each of the UEs having control information in the DCI 710 may be capable of decoding at least a portion of the DCI 710 that includes the control information for that UE.

In the example 700, the network node may encode a header 715 of the DCI 710 via a polar code or an LDPC. The network node may include, in the header 715, an indication of the UE that is associated with each set of control information in the DCI 710. For example, the header 715 may indicate that the DCI for UE1 720-a is associated with the UE1, the DCI for UE2 720-b is associated with UE2, and the DCI for UEn 720-c is associated with UEn. In some cases, the header 715 may associate each set of control information in the DCI 710 with a UE using a UE-specific identifier of the UE. The UE-specific identifiers may include a C-RNTI. Additionally, or alternatively, the UE-specific identifiers may be other UE-specific identifiers that are shorter (e.g., that include fewer bits) than a C-RNTI, which may include up to 16 bits. For example, the UE-specific identifiers may instead include a part of the C-RNTI corresponding to each UE. Here, a first portion of the C-RNTI may be used to scramble the CRC for each UE. In another example, the network node may configure UE-specific identifiers for each UE in the group of UEs (e.g., the plurality of UEs that receive the groupcast/multicast/broadcast DCI via the PDCCH resources), where the configured UE-specific identifiers are shorter than a UE-specific C-RNTI.

As shown by reference number 705, a UE may decode the DCI 710. For example, the UE may decode the header 715 of the DCI 710 to identify the one or more portions of the DCI 710 that include control information for that UE. In some cases, the UE may then decode the identified portion of the DCI 710 to obtain the decoded DCIs for that UE 725. For example, the header 715 may indicate that the DCI for UE1 720-a includes control information for the UE1, and the UE1 may then decode the DCI for UE1 720-a to obtain the decoded DCI for UE1 725-a. Additionally, or alternatively, the UEs may decode the entire DCI 710 to obtain each of the decoded DCI for the UEs 725. Then, each UE may determine which (if any) of the decoded DCIs include control information for that UE based on the information included in the header 715.

As indicated above, FIG. 7 is provided as an example. Other examples may differ from what is described with respect to FIG. 7.

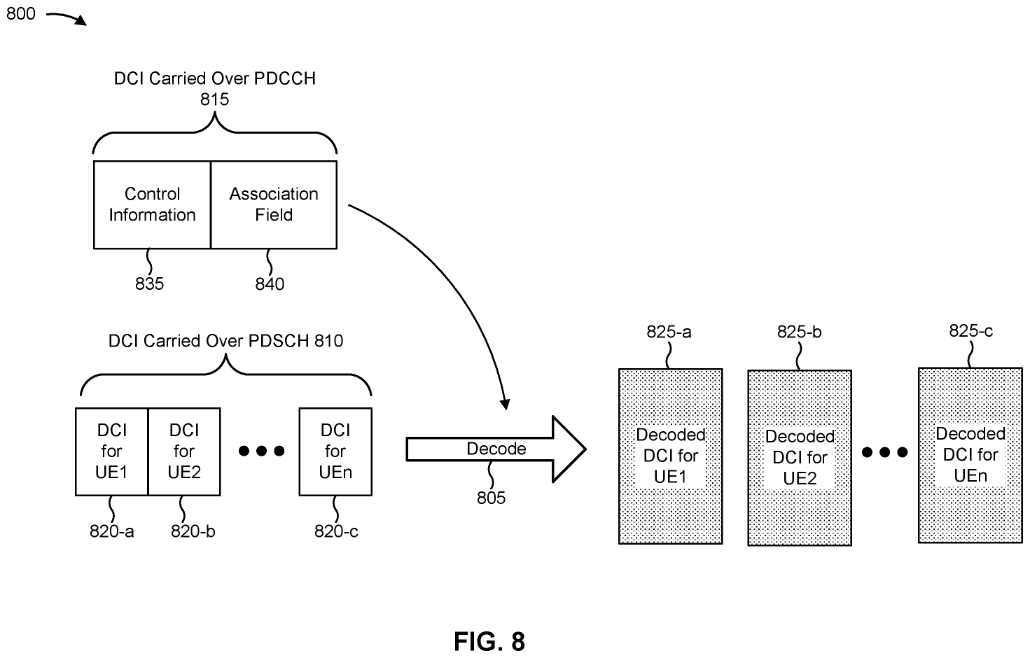

FIG. 8 is a diagram illustrating an example 800 of a process that supports PDSCH resources carrying DCI for multiple UEs, in accordance with the present disclosure. In some cases, the example 800 may include aspects of the example 400 described with respect to FIG. 4. For example, the DCI carried over PDCCH 815 may include aspects of the DCI 410-a, and the DCI carried over PDSCH 810 may include aspects of the DCI 410-b. That is, a network node may transmit control information for a group of UEs via the DCI carried over PDCCH 815 and may transmit UE-specific control information for one or more of the UEs in the group of UEs via the DCI carried over PDSCH 810.

The DCI carried over PDSCH 810 may correspond to DCI2, and may include one or more sets of control information that are UE-specific. For example, the DCI carried over PDSCH 810 may include a first set of control information that is for the UE1 (e.g., the DCI for UE1 820-a), a second set of control information that is for the UE2 (e.g., the DCI for UE2 820-b), and a third set of control information that is for the UEn (e.g., the DCI for UEn 820-c). A network node may configure the UEs to enable each of the UEs having control information in the DCI carried over PDSCH 810 to decode at least a portion of the DCI carried over PDSCH 810 that includes the control information for that UE.

In the example 800, the DCI carried over PDCCH 815 may have control information 835 (e.g., including control information for the group of UEs) and may also include the association field 840. The network node may transmit an indication of the UE that is associated with each set of control information in the DCI carried over PDSCH 810 via the association field 840 in the DCI carried over PDCCH 815. For example, the association field 840 may indicate that the DCI for UE1 820-a is associated with the UE1, the DCI for UE2 820-b is associated with UE2, and the DCI for UEn 820-c is associated with UEn. In some cases, the association field 840 may associate each set of control information in the DCI carried over PDSCH 810 with a UE using a UE-specific identifier of the UE. The UE-specific identifiers may include a C-RNTI. Additionally, or alternatively, the UE-specific identifiers may be other UE-specific identifiers that are shorter (e.g., that include fewer bits) than a C-RNTI, which may include up to 16 bits. For example, the UE-specific identifiers may instead include a part of the C-RNTI corresponding to each UE. Here, a first portion of the C-RNTI may be used to scramble the CRC for each UE. In another example, the network node may configure UE-specific identifiers for each UE in the group of UEs (e.g., the plurality of UEs that receive the groupcast/multicast/broadcast DCI via the PDCCH resources), where the configured UE-specific identifier is shorter than a UE-specific C-RNTI.

As shown by reference number 805, a UE may decode the DCI carried over PDSCH 810. For example, the UE may decode the association field 840 in the DCI carried over PDCCH 815. Based on decoding the association field 840, the UE may identify the one or more portions of the DCI carried over PDSCH 810 that include control information for that UE. In some cases, the UE may then decode the identified portion of the DCI carried over PDSCH 810 to obtain the decoded DCIs for that UE 825. For example, the association field 840 may indicate that the DCI for UE1 820-a includes control information for the UE1, and the UE1 may then decode the DCI for UE1 820-a to obtain the decoded DCI for UE1 825-a. Additionally, or alternatively, the UEs may decode the entire DCI carried over PDSCH 810 to obtain each of the decoded DCI for the UEs 825. Then, each UE may determine which (if any) of the decoded DCIs include control information for that UE based on the information included in the association field 840.

As indicated above, FIG. 8 is provided as an example. Other examples may differ from what is described with respect to FIG. 8.

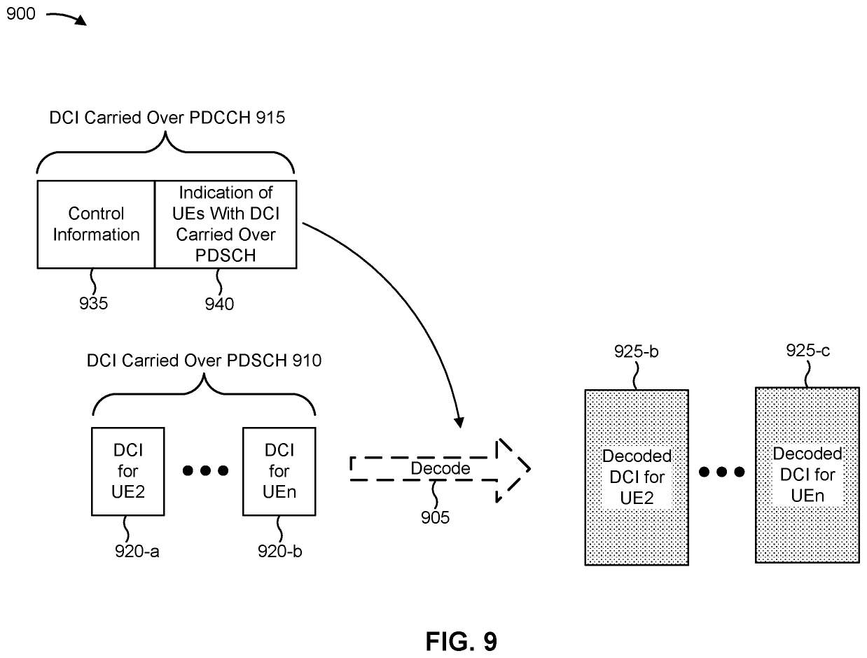

FIG. 9 is a diagram illustrating an example 900 of a process that supports PDSCH resources carrying DCI for multiple UEs, in accordance with the present disclosure. In some cases, the example 900 may include aspects of the example 400 described with respect to FIG. 4. For example, the DCI carried over PDCCH 915 may include aspects of the DCI 410-a, and the DCI carried over PDSCH 910 may include aspects of the DCI 410-b. That is, a network node may transmit control information for a group of UEs via the DCI carried over PDCCH 915, and may transmit UE-specific control information for one or more of the UEs in the group of UEs via the DCI carried over PDSCH 910.

In the example 900, the DCI carried over PDSCH 910 may include one or more sets of control information that are UE-specific. For example, the DCI carried over PDSCH 910 may include a first set of control information that is for the UE2 (e.g., the DCI for UE2 920-a) and a second set of control information that is for the UEn (e.g., the DCI for UEn 920-b). Additionally, the DCI carried over PDSCH 910 may not include UE-specific control information for one or more of the UEs in the group of UEs that receive the DCI carried over PDCCH 915. For example, the DCI carried over PDSCH 910 may not include UE-specific control information for UE1. A network node may configure the UEs to enable each of the UEs having control information in the DCI carried over PDSCH 910 to decode at least a portion of the DCI carried over PDSCH 910 that includes the control information for that UE.

The network node may transmit, and the group of UEs may receive, signaling indicating the one or more UEs that have control information in the DCI carried over PDSCH 910. For example, the network node may transmit signaling indicating that the UE2 and the UEn have control information in the DCI. In the example 900, the network node may transmit the signaling via the DCI carried over PDCCH 915. For example, the DCI carried over PDCCH 915 may include an indication of UEs with DCI carried over PDSCH 940.

In one example, the indication of UEs with DCI carried over PDSCH 940 may be carried by one or more unused fields in the DCI carried over PDCCH 915. In particular, in cases where the PDSCH resources carry DCI without carrying any downlink shared channel, the HARQ fields within the DCI carried over PDSCH 940 may be unused, as the information within the DCI carried over PDSCH 910 may be time critical, and retransmissions (e.g., via a HARQ acknowledgement (HARQ-ACK) process) may not performed. Accordingly, the indication of UEs with DCI carried over PDSCH 940 may be carried by the unused HARQ fields in the DCI carried over PDCCH 915. The unused HARQ fields may include, for example, a HARQ identifier field, an RV identifier field, and/or a new data indicator (NDI) field.

In a first instance of the indication of UEs with DCI carried over PDSCH 940 being carried over the one or more unused HARQ fields of the DCI carried over PDCCH 915, a UE may reinterpret the one or more unused HARQ fields as a hash function (e.g., a many-inputs-to-a-few output function). In another instance of the indication of UEs with DCI carried over PDSCH 940 being carried over the one or more unused HARQ fields of the DCI carried over PDCCH 915, a new field in the PDCCH 915 (e.g., that has a same quantity of bits as the one or more unused HARQ fields) may carry the indication of UEs with DCI carried over PDSCH 940.

In either instance, the indication of UEs with DCI carried over PDSCH 940 may indicate the one or more UEs having control information in the DCI carried over PDSCH 910 using a hash function. For example, the network node may configure a few (e.g., one or two) indicator bits in the DCI carried over PDCCH 915 for carrying the indication of UEs with DCI carried over PDSCH 940. These bits may indicate which UEs have control information (e.g., are assigned DCI components) in the DCI carried over PDSCH 910. For example, a position of the indicator bits in the DCI carried over PDCCH 915 may be determined via a hash algorithm that maps UE-specific identifiers of UEs that have control information in the DCI carried over PDSCH 910 to a single output. Then, each UE in the group of UEs may determine, based on the positions of the indicator bits and the hash algorithm, whether the DCI carried over PDSCH 910 includes control information for that UE.

In another example, the indication of UEs with DCI carried over PDSCH 940 may be carried by a field in the DCI carried over PDCCH 915 and may include a list of UE-specific identifiers of the UEs having control information in the DCI carried over PDSCH 910.

As indicated by reference number 905, upon receiving the indication of the one or more UEs that have control information in the DCI carried over PDSCH 910, each UE in the group of UEs may determine whether to attempt to decode the DCI carried over PDSCH 910. For example, if a UE determines that the indication of the one or more UEs that have control information in the DCI carried over PDSCH 910 indicates that UE, the UE may attempt to decode the DCI carried over PDSCH 910. Additionally, if a UE determines that the indication of the one or more UEs that have control information in the DCI carried over PDSCH 910 does not indicate that UE (e.g., the UE is not included in the one more UEs that have control information in the DCI carried over PDSCH 910), the UE may refrain from decoding the DCI carried over PDSCH 910.

In the example 900, the UE2 and UEn may determine that the one or more UEs indicated as having control information in the DCI carried over PDSCH 910 does include the UE2 and UEn, and may therefore attempt to decode the DCI carried over PDSCH 910 to obtain the decoded DCI for UE2 925-b and the decoded DCI for UEn 925-c. Additionally, the UE1 may determine that the one or more UEs indicated as having control information in the DCI carried over PDSCH 910 does not include the UE1, and may therefore refrain from attempting to decode the DCI carried over PDSCH 910.

As indicated above, FIG. 9 is provided as an example. Other examples may differ from what is described with respect to FIG. 9.

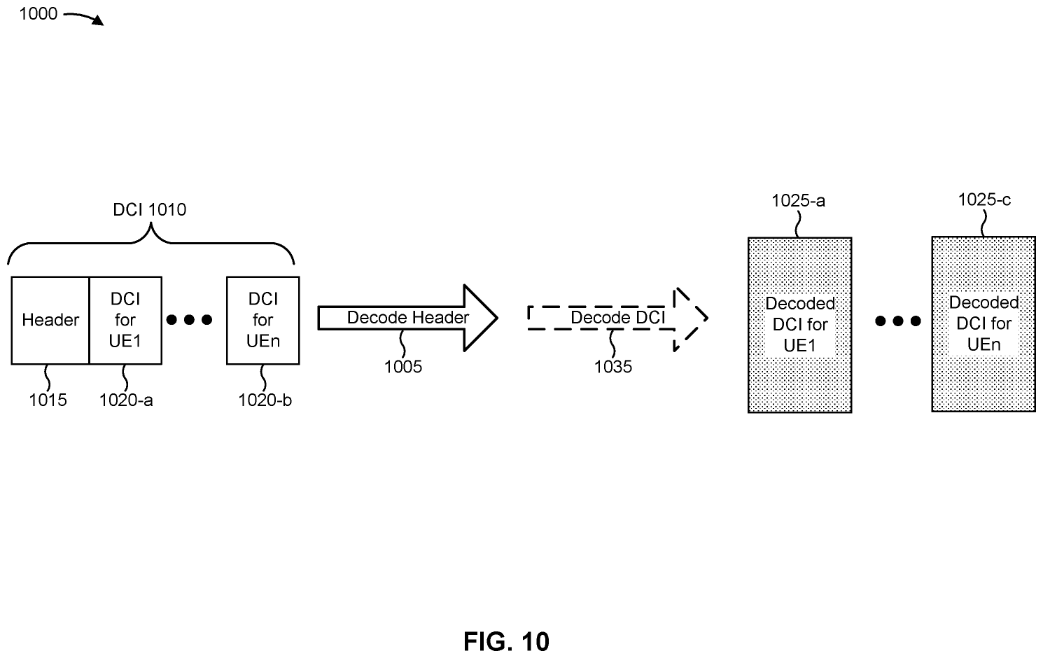

FIG. 10 is a diagram illustrating an example 1000 of a process that supports PDSCH resources carrying DCI for multiple UEs, in accordance with the present disclosure. In some cases, the example 1000 may include aspects of the example 400 described with respect to FIG. 4. For example, the DCI 1010 may include aspects of the DCI 410-b. That is, a network node may transmit control information for a group of UEs via a DCI carried by PDCCH resources (e.g., a DCI1) and may transmit UE-specific control information for one or more of the UEs in the group of UEs via the DCI 1010, where the DCI 1010 is carried by PDSCH resources that carry the DCI 1010 without carrying a downlink shared channel.

In the example 1000, the DCI 1010 may include one or more sets of control information that are UE-specific. For example, the DCI 1010 may include a first set of control information that is for the UE1 (e.g., the DCI for UE1 1020-a) and a second set of control information that is for the UEn (e.g., the DCI for UEn 1020-b). Additionally, the DCI 1010 may not include UE-specific control information for one or more of the UEs in the group of UEs. For example, the DCI 1010 may not include UE-specific control information for UE2. A network node may configure the UEs to enable each of the UEs having control information in the DCI 1010 to decode at least a portion of the DCI 1010 that includes the control information for that UE.

The network node may transmit, and the group of UEs may receive, signaling indicating the one or more UEs that have control information in the DCI 1010. For example, the network node may transmit signaling indicating that the UE1 and the UEn have control information in the DCI 1010. In the example 1000, the network node may transmit the signaling via a header 1015 in the DCI 1010. In the example 1000, the DCI 1010 may be configured according to a two-stage structure, where a first stage may comprise the header 1015 and the second stage comprises the UE-specific control information (e.g., the DCI for UE1 1020-a and the DCI for UEn 1020-b). Here, as indicated by reference number 1005, each of the UEs in the group may decode the header 1015, and as indicated by reference number 1035, the one or more UEs indicated as having control information in the DCI 1010 (e.g., by the header 1015) may decode at least a portion of the DCI 1010 having the UE-specific control information.

In some cases, the DCI transmitted via the PDCCH (e.g., the DCI1) may indicate a size (e.g., via a TDRA, FDRA, and/or number of bits) of the header 1015. To enable each of the UEs in the group of UEs to decode (as indicated by reference number 1005) the header 1015, the header 1015 may include its own DMRS with a specific pattern. For example, the network node may indicate the pattern for the DMRS in the header 1015 via the DCI carried over the PDCCH resources. Additionally, the network node may encode the header 1015 to enable UEs to decode the header 1015 using a CRC-based polar code. In some cases, the header 1015 may be small in size (e.g., the TDRA, FDRA, and/or number of bits associated with the header 1015 may be small) to enable the group of UEs to decode the header 1015 quickly (e.g., as compared to a header that is larger). In some instances, the DMRS and the resource elements in the header 1015 may be frequency division multiplexed (FDMed), which may further decrease a size of the header 1015. Here, an FDRA DMRS pattern of the header 1015 may include aspects of a frequency domain DMRS pattern. for example, the DMRS and header resource elements of the header 1015 may be FDMed with 25% or 33% frequency domain density. Additionally, or alternatively, a TDRA DMRS pattern of the DMRS in the header 1015 may be based on a TDRA of the header 1015.

To indicate the one or more UEs that have control information in the DCI 1010, the header 1015 may include a list of UE-specific identifiers. Here, the header 1015 may additionally indicate an association between the UE-specific identifiers and one of the sets of control information in the DCI 1010 (e.g., the DCI for UE1 1020-a and the DCI for UEn 1020-b). If the header does indicate the association between the UE-specific identifiers and one of the sets of control information in the DCI 1010, the sets of control information in the DCI 1010 (e.g., the payload of the DCI, the DCI component for a UE, the DCI for a UE 1020) may not include a UE-specific identifier.

Upon receiving the indication of the one or more UEs that have control information in the DCI 1010, each UE in the group of UEs may determine whether to attempt to decode (as indicated by reference number 1035) the remaining portions of the DCI 1010 (e.g., that includes the UE-specific control information). For example, if a UE determines that the indication of the one or more UEs that have control information in the DCI 1010 indicates that UE, the UE may attempt to decode the DCI 1010. Additionally, if a UE determines that the indication of the one or more UEs that have control information in the DCI 1010 does not indicate that UE (e.g., the UE is not included in the one more UEs that have control information in the DCI 1010), the UE may refrain from decoding the DCI 1010.

In the example 1000, the UE1 and UEn may determine that the one or more UEs indicated as having control information in the DCI 1010 does include the UE1 and UEn, and may therefore attempt to decode (as indicated by reference number 1035) the DCI 1010 to obtain the decoded DCI for UE1 1025-a and the decoded DCI for UEn 1025-c. Additionally, the UE2 may determine that the one or more UEs indicated as having control information in the DCI 1010 does not include the UE2, and may therefore refrain from attempting to decode the DCI 1010.

As indicated above, FIG. 10 is provided as an example. Other examples may differ from what is described with respect to FIG. 10.

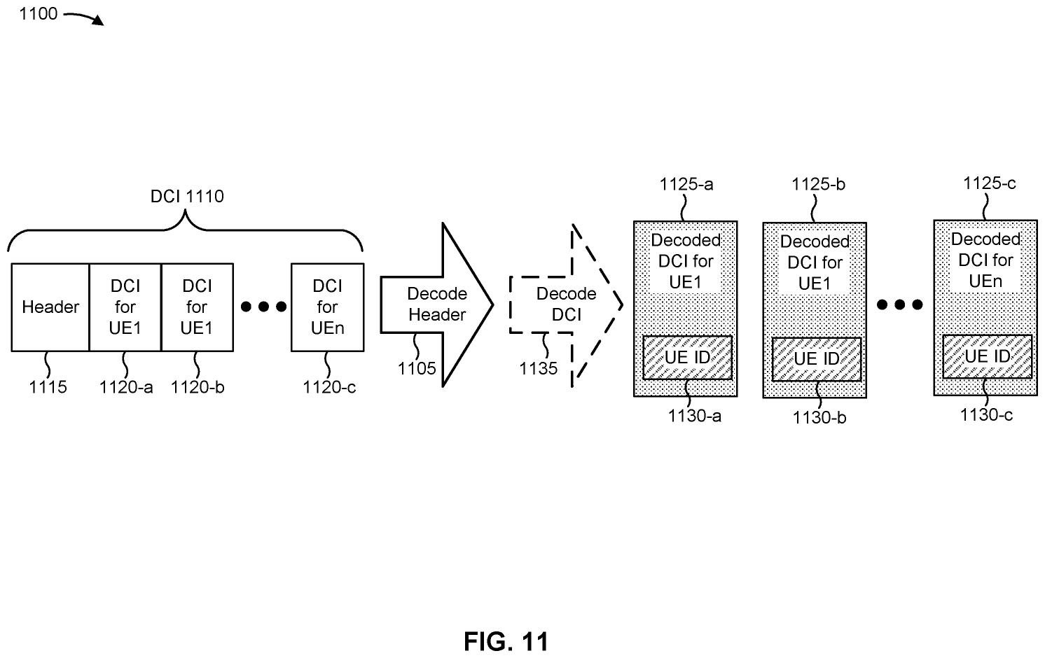

FIG. 11 is a diagram illustrating an example 1100 of a process that supports PDSCH resources carrying DCI for multiple UEs, in accordance with the present disclosure. In some cases, the example 1100 may include aspects of the example 400 described with respect to FIG. 4. For example, the DCI 1110 may include aspects of the DCI 410-b. That is, a network node may transmit control information for a group of UEs via a DCI carried by PDCCH resources (e.g., a DCI1) and may transmit UE-specific control information for one or more of the UEs in the group of UEs via the DCI 1110, where the DCI 1110 is carried by PDSCH resources that carry the DCI 1110 without carrying a downlink shared channel. Example 1100 may additionally include aspects of the example 1000 described with reference to FIG. 10. For example, the DCI 1110 may include aspects of the DCI 1010, such as being configured according to a two-stage structure.

In the example 1100, the DCI 1110 may include one or more sets of control information that are UE-specific. For example, the DCI 1110 may include a first set of control information that is for the UE1 (e.g., the DCI for UE1 1120-a), a third set of control information that is for the UE1 (e.g., the DCI for UE1 1120-b), and a second set of control information that is for the UEn (e.g., the DCI for UEn 1120-b). Additionally, the DCI 1110 may not include UE-specific control information for one or more of the UEs in the group of UEs. For example, the DCI 1110 may not include UE-specific control information for UE2. A network node may configure the UEs to enable each of the UEs having control information in the DCI 1110 to decode at least a portion of the DCI 1110 that includes the control information for that UE.

The network node may transmit, and the group of UEs may receive, signaling indicating the one or more UEs that have control information in the DCI 1110. For example, the network node may transmit signaling indicating that the UE1 and the UEn have control information in the DCI 1110. In the example 1100, the network node may transmit the signaling via a header 1115 in the DCI 1110. In the example 1100, the DCI 1110 may be configured according to a two-stage structure, where a first stage may comprise the header 1115 and the second stage comprises the UE-specific control information (e.g., the DCI for UE1 1120-a and the DCI for UEn 1120-b). Here, as indicated by reference number 1105, each of the UEs in the group may decode the header 1115, and as indicated by reference number 1135, the one or more UEs indicated as having control information in the DCI 1110 (e.g., by the header 1115) may decode at least a portion of the DCI 1110 having the UE-specific control information.

The header 1115 may indicate the one or more UEs that have control information in the DCI 1110 via a hash algorithm. Here, the header 1115 may be based on a hash algorithm associated with the UE-specific identifiers of the UEs that have control information in the DCI 1110. To determine whether the UE has UE-specific control information in the DCI 1110, each UE may apply a hash checking algorithm to the header 1115. In this example, the sets of control information in the DCI 1110 (e.g., the payload of the DCI, the DCI component for a UE, the DCI for a UE 1120) may include a UE-specific identifier 1130.

Upon receiving the indication of the one or more UEs that have control information in the DCI 1110, each UE in the group of UEs may determine whether to attempt to decode the remaining portions of the DCI 1110 (e.g., that includes the UE-specific control information). For example, if a UE determines that the indication of the one or more UEs that have control information in the DCI 1110 indicates that UE, the UE may attempt to decode the DCI 1110. Additionally, if a UE determines that the indication of the one or more UEs that have control information in the DCI 1110 does not indicate that UE (e.g., the UE is not included in the one more UEs that have control information in the DCI 1110), the UE may refrain from decoding the DCI 1110.

In the example 1100, the UE1 and UEn may determine that the one or more UEs indicated as having control information in the DCI 1110 does include the UE1 and UEn, and may therefore attempt to decode the DCI 1110 to obtain the decoded DCI for UE1 1125-a, the decoded DCI for UE1 1125-b, and the decoded DCI for UEn 1125-c. Additionally, the UE2 may determine that the one or more UEs indicated as having control information in the DCI 1110 does not include the UE2, and may therefore refrain from attempting to decode the DCI 1110. The UEs may identify which set of decoded control information includes control information for that UE based on the UE-specific identifier 1130 included in the DCI 1110. For example, the UE1 may identify that the decoded DCI for UE1 1125-a and 1125-b includes control information for UE1 based on the UE IDs 1130-a and 1130-b being UE-specific identifiers of UE1. Additionally, the UEn may identify that the decoded DCI for UEn 1125-c includes control information for UEn based on the UE ID 1130-c being a UE-specific identifier of UEn.

As indicated above, FIG. 11 is provided as an example. Other examples may differ from what is described with respect to FIG. 11.

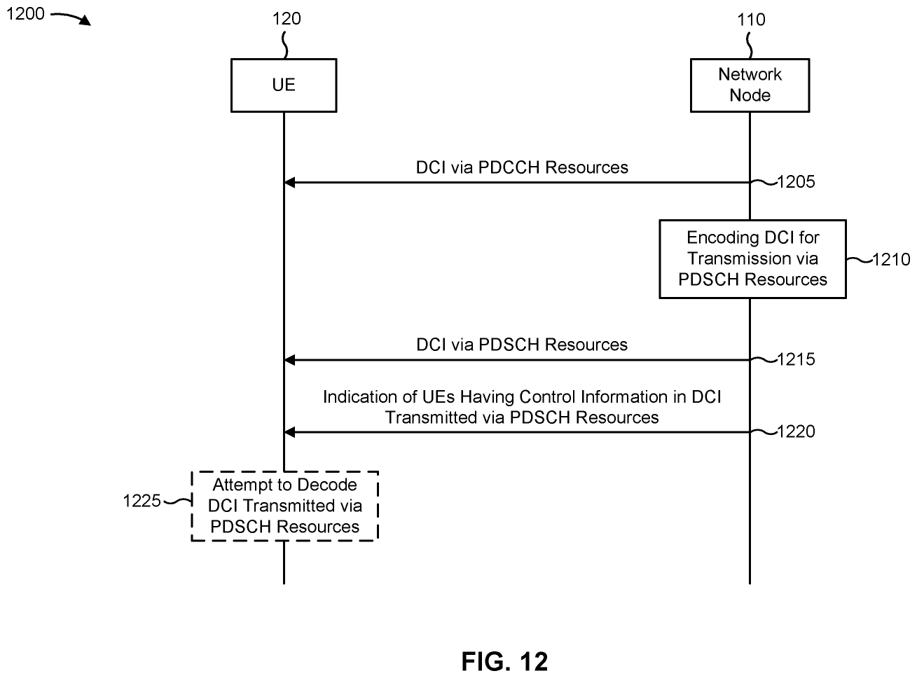

FIG. 12 is a diagram illustrating an example 1200 of signaling exchanged between a network node 110 and UE 120, in accordance with the present disclosure. In some cases, the network node 110 and UE 120 described with reference to the wireless communication network 400 may implement aspects of the example 1200.

As shown by reference number 1205, the network node 110 may transmit, and the UE 120 may receive, first DCI (e.g., DCI1) via a PDCCH, the first DCI comprising control information for a plurality of UEs and indicating resources of a PDSCH that carry second DCI without carrying a downlink shared channel. In some cases, the first DCI may include DCI that is shared between the plurality of UEs (e.g., that is not UE-specific control information).

As shown by reference number 1210, the network node 110 may encode second DCI (e.g., DCI2) for transmission via the PDSCH resources. In some cases, the second DCI may include UE-specific DCI for one or more UEs in the plurality of UEs.

As shown by reference number 1215, the network node 110 may transmit, and the UE 115 may receive, the second DCI that comprises control information for the one or more UEs from the plurality of UEs.

As shown by reference number 1220, the network node 110 may transmit, and the UE 120 may receive, an indication of the one or more UEs that have control information in the second DCI.

As shown by reference number 1225, the UE 120 may optionally attempt to decode at least a portion of the second DCI based at least in part on whether the one or more UEs that have the control information in the second DCI comprise the UE 120. For example, the UE 120 may attempt to decode at least the portion of the second DCI to obtain control information for the UE 120 if the one or more UEs that have the control information in the second DCI include the first UE. Additionally, the UE 120 may refrain from decoding at least the portion of the second DCI if the one or more UEs that have the control information in the second DCI do not include the UE 120.

As indicated above, FIG. 12 is provided as an example. Other examples may differ from what is described with respect to FIG. 12.

FIG. 13 is a diagram illustrating an example process 1300 performed, for example, at a first UE or an apparatus of a UE, in accordance with the present disclosure. Example process 1300 is an example where the apparatus or the UE (e.g., UE 120) performs operations associated with PDSCH resources that carry DCI for multiple UEs.

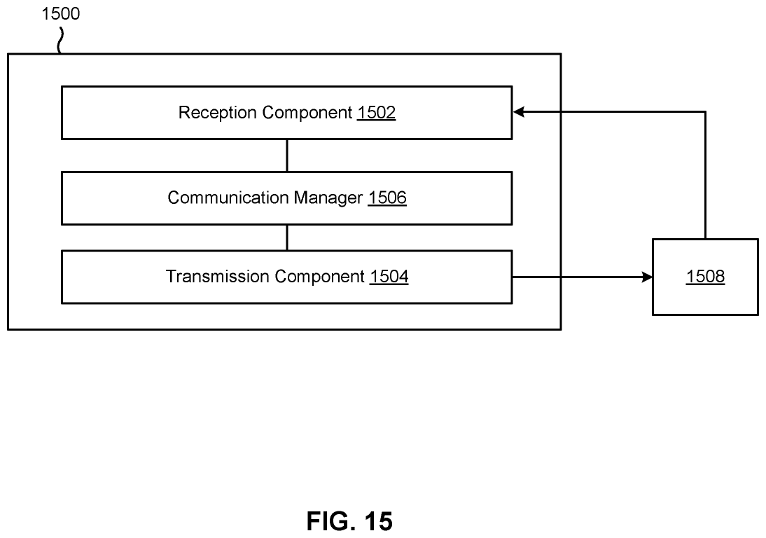

As shown in FIG. 13, in some aspects, process 1300 may include receiving, from a network node, first DCI via a PDCCH, the first DCI comprising control information for a plurality of UEs and indicating resources of a PDSCH that carry second DCI without carrying a downlink shared channel (block 1310). For example, the first UE (e.g., using reception component 1502 and/or communication manager 1506, depicted in FIG. 15) may receive, from a network node, first DCI via a PDCCH, the first DCI comprising control information for a plurality of UEs and indicating resources of a PDSCH that carry second DCI without carrying a downlink shared channel, as described above.

As further shown in FIG. 13, in some aspects, process 1300 may include receiving, via the resources of the PDSCH, the second DCI from the network node, the second DCI comprising control information for one or more UEs from the plurality of UEs (block 1320). For example, the first UE (e.g., using reception component 1502 and/or communication manager 1506, depicted in FIG. 15) may receive, via the resources of the PDSCH, the second DCI from the network node, the second DCI comprising control information for one or more UEs from the plurality of UEs, as described above.

As further shown in FIG. 13, in some aspects, process 1300 may include receiving, from the network node, an indication of the one or more UEs that have control information in the second DCI (block 1330). For example, the first UE (e.g., using reception component 1502 and/or communication manager 1506, depicted in FIG. 15) may receive, from the network node, an indication of the one or more UEs that have control information in the second DCI, as described above.

As further shown in FIG. 13, in some aspects, process 1300 may include determining whether to attempt to decode at least a portion of the second DCI based at least in part on whether the one or more UEs that have the control information in the second DCI comprise the first UE (block 1340). For example, the first UE (e.g., using communication manager 1506, depicted in FIG. 15) may determine whether to attempt to decode at least a portion of the second DCI based at least in part on whether the one or more UEs that have the control information in the second DCI comprise the first UE, as described above.

Process 1300 may include additional aspects, such as any single aspect or any combination of aspects described below and/or in connection with one or more other processes described elsewhere herein.

In a first aspect, process 1300 includes attempting to decode at least the portion of the second DCI to obtain control information for the first UE based at least in part on the one or more UEs that have the control information in the second DCI comprising the first UE.

In a second aspect, process 1300 includes attempting to decode at least the portion of the second DCI based at least in part on an identifier associated with the first UE, the second DCI comprising a plurality of sets of control information that each comprise control information for one of the one or more UEs.

In a third aspect, attempting to decode at least the portion of the second DCI comprises descrambling a cyclic redundancy check in the second DCI with the identifier associated with the first UE, wherein the identifier is associated with the plurality of UEs, and process 1300 includes identifying one or more sets of control information, from the plurality of sets of control information, that comprise control information for the first UE based at least in part on the one or more sets of control information comprising a UE-specific identifier of the first UE.

In a fourth aspect, attempting to decode at least the portion of the second DCI comprises attempting to descramble, with the identifier associated with the first UE, a plurality of cyclic redundancy checks in the second DCI that are each associated with one of the plurality of sets of control information, wherein the identifier comprises a UE-specific identifier of the first UE, and process 1300 includes identifying one or more sets of control information, from the plurality of sets of control information, that comprise control information for the first UE in response to successfully descrambling one or more cyclic redundancy checks associated with the one or more sets of control information using the UE-specific identifier of the first UE.

In a fifth aspect, attempting to decode at least the portion of the second DCI comprises decoding a header of the second DCI, the header indicating one of the one or more UEs associated with each subset of the plurality of sets of control information, and process 1300 includes identifying one or more sets of control information, from the plurality of sets of control information, that comprise control information for the first UE based at least in part on the header of the second DCI indicating that the one or more sets of control information are associated with the first UE.

In a sixth aspect, process 1300 includes decoding a field in the first DCI that indicates one of the one or more UEs associated with each subset of the plurality of sets of control information, and identifying one or more sets of control information in the second DCI, from the plurality of sets of control information, that comprise control information for the first UE based at least in part on the field in the first DCI indicating that the one or more sets of control information are associated with the first UE.

In a seventh aspect, the identifier comprises at least a portion of a UE-specific RNTI, a broadcast RNTI, a multicast RNTI, or a group RNTI configured by the network node.

In an eighth aspect, process 1300 includes refraining from attempting to decode at least the portion of the second DCI to obtain control information for the first UE based at least in part on the one or more UEs that have the control information in the second DCI not comprising the first UE.

In a ninth aspect, receiving the indication comprises receiving the indication via the PDCCH.

In a tenth aspect, the indication comprises a plurality of bits that indicate, via a hash algorithm, the one or more UEs that have the control information in the second DCI.

In an eleventh aspect, the first DCI comprises one or more UE identifiers corresponding to the one or more UEs.

In a twelfth aspect, process 1300 includes decoding a header of the second DCI that comprises the indication of the one or more UEs that have the control information in the second DCI, wherein determining whether to attempt to decode at least the portion of the second DCI is based at least in part on whether the one or more UEs indicated in the header of the second DCI comprise the first UE.

In a thirteenth aspect, process 1300 includes the header of the second DCI comprises one or more UE identifiers corresponding to the one or more UEs, the header of the second DCI indicates, for each of the one or more UEs, PDSCH resources carrying control information for a respective one of the one or more UEs, and process 1300 includes attempting to decode at least the portion of the second DCI carried by the PDSCH resources indicated as carrying the control information for the first UE, based at least in part on the one or more UE identifiers in the header of the second DCI comprising a first UE identifier corresponding to the first UE.

In a fourteenth aspect, process 1300 includes the header of the second DCI comprises a plurality of bits that indicate, via a hash algorithm, the one or more UEs that have the control information in the second DCI, the second DCI comprises a plurality of sets of control information that are each for one of the one or more UEs, and the second DCI comprises a plurality of UE identifiers each corresponding to a respective one of the plurality of sets of control information, the one or more UE identifiers indicating, for the respective one of the plurality of sets of control information, one of the one or more UEs that is associated with the respective one of the plurality of sets of control information.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a network node or an apparatus of a network node, in accordance with the present disclosure. Example process 1400 is an example where the apparatus or the network node (e.g., network node 110) performs operations associated with PDSCH resources that carry DCI for multiple UEs.

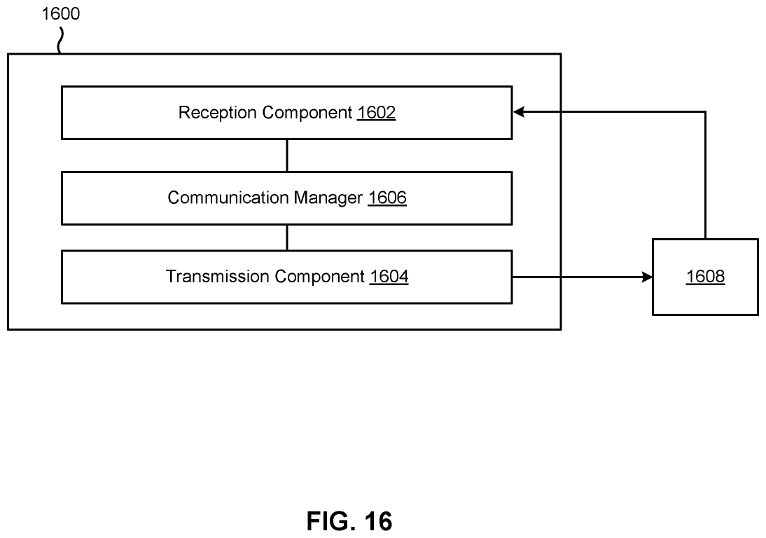

As shown in FIG. 14, in some aspects, process 1400 may include transmitting, to a plurality of UEs, first DCI via a PDCCH, the first DCI comprising control information for the plurality of UEs and indicating resources of a PDSCH that carry second DCI without carrying a downlink shared channel (block 1410). For example, the network node (e.g., using transmission component 1604 and/or communication manager 1606, depicted in FIG. 16) may transmit, to a plurality of UEs, first DCI via a PDCCH, the first DCI comprising control information for the plurality of UEs and indicating resources of a PDSCH that carry second DCI without carrying a downlink shared channel, as described above.

As further shown in FIG. 14, in some aspects, process 1400 may include transmitting, via the resources of the PDSCH and to one or more UEs from the plurality of UEs, the second DCI comprising control information for the one or more UEs from the plurality of UEs (block 1420). For example, the network node (e.g., using transmission component 1604 and/or communication manager 1606, depicted in FIG. 16) may transmit, via the resources of the PDSCH and to one or more UEs from the plurality of UEs, the second DCI comprising control information for the one or more UEs from the plurality of UEs, as described above.

As further shown in FIG. 14, in some aspects, process 1400 may include transmitting, to the plurality of UEs, an indication of the one or more UEs that have control information in the second DCI (block 1430). For example, the network node (e.g., using transmission component 1604 and/or communication manager 1606, depicted in FIG. 16) may transmit, to the plurality of UEs, an indication of the one or more UEs that have control information in the second DCI, as described above.

Process 1400 may include additional aspects, such as any single aspect or any combination of aspects described below and/or in connection with one or more other processes described elsewhere herein.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication, in accordance with the present disclosure. The apparatus 1500 may be a UE, or a UE may include the apparatus 1500. In some aspects, the apparatus 1500 includes a reception component 1502, a transmission component 1504, and/or a communication manager 1506, which may be in communication with one another (for example, via one or more buses and/or one or more other components). In some aspects, the communication manager 1506 is the communication manager 140 described in connection with FIG. 1. As shown, the apparatus 1500 may communicate with another apparatus 1508, such as a UE or a network node (such as a CU, a DU, an RU, or a base station), using the reception component 1502 and the transmission component 1504.

In some aspects, the apparatus 1500 may be configured to perform one or more operations described herein in connection with FIGS. 4-12. Additionally, or alternatively, the apparatus 1500 may be configured to perform one or more processes described herein, such as process 1300 of FIG. 13. In some aspects, the apparatus 1500 and/or one or more components shown in FIG. 15 may include one or more components of the UE described in connection with FIG. 2. Additionally, or alternatively, one or more components shown in FIG. 15 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1508. In some aspects, the transmission component 1504 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1504 may be co-located with the reception component 1502 in one or more transceivers.

The communication manager 1506 may support operations of the reception component 1502 and/or the transmission component 1504. For example, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The reception component 1502 may receive, from a network node, first DCI via a PDCCH, the first DCI comprising control information for a plurality of UEs and indicating resources of a PDSCH that carry second DCI without carrying a downlink shared channel. The reception component 1502 may receive, via the resources of the PDSCH, the second DCI from the network node, the second DCI comprising control information for one or more UEs from the plurality of UEs. The reception component 1502 may receive, from the network node, an indication of the one or more UEs that have control information in the second DCI. The communication manager 1506 may determine whether to attempt to decode at least a portion of the second DCI based at least in part on whether the one or more UEs that have the control information in the second DCI comprise the first UE.

The communication manager 1506 may attempt to decode at least the portion of the second DCI to obtain control information for the first UE based at least in part on the one or more UEs that have the control information in the second DCI comprising the first UE.

The communication manager 1506 may attempt to decode at least the portion of the second DCI based at least in part on an identifier associated with the first UE, the second DCI comprising a plurality of sets of control information that each comprise control information for one of the one or more UEs.

The communication manager 1506 may decode a field in the first DCI that indicates one of the one or more UEs associated with each subset of the plurality of sets of control information.

The communication manager 1506 may identify one or more sets of control information in the second DCI, from the plurality of sets of control information, that comprise control information for the first UE based at least in part on the field in the first DCI indicating that the one or more sets of control information are associated with the first UE.

The communication manager 1506 may refrain from attempting to decode at least the portion of the second DCI to obtain control information for the first UE based at least in part on the one or more UEs that have the control information in the second DCI not comprising the first UE.

The communication manager 1506 may decode a header of the second DCI that comprises the indication of the one or more UEs that have the control information in the second DCI, wherein determining whether to attempt to decode at least the portion of the second DCI is based at least in part on whether the one or more UEs indicated in the header of the second DCI comprise the first UE.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication, in accordance with the present disclosure. The apparatus 1600 may be a network node, or a network node may include the apparatus 1600. In some aspects, the apparatus 1600 includes a reception component 1602, a transmission component 1604, and/or a communication manager 1606, which may be in communication with one another (for example, via one or more buses and/or one or more other components). In some aspects, the communication manager 1606 is the communication manager 150 described in connection with FIG. 1. As shown, the apparatus 1600 may communicate with another apparatus 1608, such as a UE or a network node (such as a CU, a DU, an RU, or a base station), using the reception component 1602 and the transmission component 1604.

In some aspects, the apparatus 1600 may be configured to perform one or more operations described herein in connection with FIGS. 4-11. Additionally, or alternatively, the apparatus 1600 may be configured to perform one or more processes described herein, such as process 1400 of FIG. 14. In some aspects, the apparatus 1600 and/or one or more components shown in FIG. 16 may include one or more components of the network node described in connection with FIG. 2. Additionally, or alternatively, one or more components shown in FIG. 16 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1600. In some aspects, the reception component 1602 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1602 and/or the transmission component 1604 may include or may be included in a network interface. The network interface may be configured to obtain and/or output signals for the apparatus 1600 via one or more communications links, such as a backhaul link, a midhaul link, and/or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1608. In some aspects, the transmission component 1604 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1604 may be co-located with the reception component 1602 in one or more transceivers.

The communication manager 1606 may support operations of the reception component 1602 and/or the transmission component 1604. For example, the communication manager 1606 may receive information associated with configuring reception of communications by the reception component 1602 and/or transmission of communications by the transmission component 1604. Additionally, or alternatively, the communication manager 1606 may generate and/or provide control information to the reception component 1602 and/or the transmission component 1604 to control reception and/or transmission of communications.

The transmission component 1604 may transmit, to a plurality of UEs, first DCI via a PDCCH, the first DCI comprising control information for the plurality of UEs and indicating resources of a PDSCH that carry second DCI without carrying a downlink shared channel. The transmission component 1604 may transmit, via the resources of the PDSCH and to one or more UEs from the plurality of UEs, the second DCI comprising control information for the one or more UEs from the plurality of UEs. The transmission component 1604 may transmit, to the plurality of UEs, an indication of the one or more UEs that have control information in the second DCI.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a first UE, comprising: receiving, from a network node, first DCI via a PDCCH, the first DCI comprising control information for a plurality of UEs and indicating resources of a PDSCH that carry second DCI without carrying a downlink shared channel; receiving, via the resources of the PDSCH, the second DCI from the network node, the second DCI comprising control information for one or more UEs from the plurality of UEs; receiving, from the network node, an indication of the one or more UEs that have control information in the second DCI; and determining whether to attempt to decode at least a portion of the second DCI based at least in part on whether the one or more UEs that have the control information in the second DCI comprise the first UE.

Aspect 2: The method of Aspect 1, further comprising: attempting to decode at least the portion of the second DCI to obtain control information for the first UE based at least in part on the one or more UEs that have the control information in the second DCI comprising the first UE.

Aspect 3: The method of Aspect 2, further comprising: attempting to decode at least the portion of the second DCI based at least in part on an identifier associated with the first UE, the second DCI comprising a plurality of sets of control information that each comprise control information for one of the one or more UEs.

Aspect 4: The method of Aspect 3, wherein: attempting to decode at least the portion of the second DCI comprises descrambling a cyclic redundancy check in the second DCI with the identifier associated with the first UE, wherein the identifier is associated with the plurality of UEs; and the method further comprises identifying one or more sets of control information, from the plurality of sets of control information, that comprise control information for the first UE based at least in part on the one or more sets of control information comprising a UE-specific identifier of the first UE.

Aspect 5: The method of Aspect 3, wherein: attempting to decode at least the portion of the second DCI comprises attempting to descramble, with the identifier associated with the first UE, a plurality of cyclic redundancy checks in the second DCI that are each associated with one of the plurality of sets of control information, wherein the identifier comprises a UE-specific identifier of the first UE; and the method further comprises identifying one or more sets of control information, from the plurality of sets of control information, that comprise control information for the first UE in response to successfully descrambling one or more cyclic redundancy checks associated with the one or more sets of control information using the UE-specific identifier of the first UE.

Aspect 6: The method of Aspect 3, wherein: attempting to decode at least the portion of the second DCI comprises decoding a header of the second DCI, the header indicating one of the one or more UEs associated with each subset of the plurality of sets of control information; and the method further comprises identifying one or more sets of control information, from the plurality of sets of control information, that comprise control information for the first UE based at least in part on the header of the second DCI indicating that the one or more sets of control information are associated with the first UE.

Aspect 7: The method of Aspect 3, further comprising: decoding a field in the first DCI that indicates one of the one or more UEs associated with each subset of the plurality of sets of control information; and identifying one or more sets of control information in the second DCI, from the plurality of sets of control information, that comprise control information for the first UE based at least in part on the field in the first DCI indicating that the one or more sets of control information are associated with the first UE.

Aspect 8: The method of Aspect 3, wherein the identifier comprises at least a portion of a UE-specific RNTI, a broadcast RNTI, a multicast RNTI, or a group RNTI configured by the network node.

Aspect 9: The method of any of Aspects 1-8, further comprising: refraining from attempting to decode at least the portion of the second DCI to obtain control information for the first UE based at least in part on the one or more UEs that have the control information in the second DCI not comprising the first UE.

Aspect 10: The method of any of Aspects 1-9, wherein receiving the indication comprises receiving the indication via the PDCCH.

Aspect 11: The method of Aspect 10, wherein the indication comprises a plurality of bits that indicate, via a hash algorithm, the one or more UEs that have the control information in the second DCI.

Aspect 12: The method of Aspect 10, wherein the first DCI comprises one or more UE identifiers corresponding to the one or more UEs.

Aspect 13: The method of any of Aspects 1-12, further comprising: decoding a header of the second DCI that comprises the indication of the one or more UEs that have the control information in the second DCI, wherein determining whether to attempt to decode at least the portion of the second DCI is based at least in part on whether the one or more UEs indicated in the header of the second DCI comprise the first UE.

Aspect 14: The method of Aspect 13, wherein: the header of the second DCI comprises one or more UE identifiers corresponding to the one or more UEs; the header of the second DCI indicates, for each of the one or more UEs, PDSCH resources carrying control information for a respective one of the one or more UEs; and the method further comprises attempting to decode at least the portion of the second DCI carried by the PDSCH resources indicated as carrying the control information for the first UE, based at least in part on the one or more UE identifiers in the header of the second DCI comprising a first UE identifier corresponding to the first UE.

Aspect 15: The method of Aspect 13, wherein: the header of the second DCI comprises a plurality of bits that indicate, via a hash algorithm, the one or more UEs that have the control information in the second DCI; the second DCI comprises a plurality of sets of control information that are each for one of the one or more UEs; and the second DCI comprises a plurality of UE identifiers each corresponding to a respective one of the plurality of sets of control information, the one or more UE identifiers indicating, for the respective one of the plurality of sets of control information, one of the one or more UEs that is associated with the respective one of the plurality of sets of control information.

Aspect 16: A method of wireless communication performed by a network node, comprising: transmitting, to a plurality of UEs, first DCI via a PDCCH, the first DCI comprising control information for the plurality of UEs and indicating resources of a PDSCH that carry second DCI without carrying a downlink shared channel; transmitting, via the resources of the PDSCH and to one or more UEs from the plurality of UEs, the second DCI comprising control information for the one or more UEs from the plurality of UEs; and transmitting, to the plurality of UEs, an indication of the one or more UEs that have control information in the second DCI.

Aspect 17: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-16.

Aspect 18: An apparatus for wireless communication at a device, the apparatus comprising one or more memories and one or more processors coupled to the one or more memories, the one or more processors configured to cause the device to perform the method of one or more of Aspects 1-16.

Aspect 19: An apparatus for wireless communication, the apparatus comprising at least one means for performing the method of one or more of Aspects 1-16.

Aspect 20: A non-transitory computer-readable medium storing code for wireless communication, the code comprising instructions executable by one or more processors to perform the method of one or more of Aspects 1-16.

Aspect 21: A non-transitory computer-readable medium storing a set of instructions for wireless communication, the set of instructions comprising one or more instructions that, when executed by one or more processors of a device, cause the device to perform the method of one or more of Aspects 1-16.

Aspect 22: A device for wireless communication, the device comprising a processing system that includes one or more processors and one or more memories coupled with the one or more processors, the processing system configured to cause the device to perform the method of one or more of Aspects 1-16.

Aspect 23: An apparatus for wireless communication at a device, the apparatus comprising one or more memories and one or more processors coupled to the one or more memories, the one or more processors individually or collectively configured to cause the device to perform the method of one or more of Aspects 1-16.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a first user equipment (UE), comprising:
one or more memories; and
one or more processors coupled with the one or more memories and configured to cause the first UE to:
receive, from a network node, first downlink control information (DCI) via a physical downlink control channel (PDCCH), the first DCI comprising control information for a plurality of UEs and indicating resources of a physical downlink shared channel (PDSCH) that carry second DCI without carrying a downlink shared channel;
receive, via the resources of the PDSCH, the second DCI from the network node, the second DCI comprising control information for one or more UEs from the plurality of UEs;
receive, from the network node, an indication of the one or more UEs that have control information in the second DCI; and
determine whether to attempt to decode at least a portion of the second DCI based at least in part on whether the one or more UEs that have the control information in the second DCI comprise the first UE.

2. The apparatus of claim 1, wherein the one or more processors are further configured to cause the first UE to:
attempt to decode at least the portion of the second DCI to obtain control information for the first UE based at least in part on the one or more UEs that have the control information in the second DCI comprising the first UE.

3. The apparatus of claim 2, wherein the one or more processors are further configured to cause the first UE to:
attempt to decode at least the portion of the second DCI based at least in part on an identifier associated with the first UE, the second DCI comprising a plurality of sets of control information that each comprise control information for one of the one or more UEs.

4. The apparatus of claim 3, wherein:
to attempt to decode at least the portion of the second DCI, the one or more processors are configured to cause the first UE to descramble a cyclic redundancy check in the second DCI with the identifier associated with the first UE, wherein the identifier is associated with the plurality of UEs; and
the one or more processors are further configured to cause the first UE to identify one or more sets of control information, from the plurality of sets of control information, that comprise control information for the first UE based at least in part on the one or more sets of control information comprising a UE-specific identifier of the first UE.

5. The apparatus of claim 3, wherein:
to attempt to decode at least the portion of the second DCI, the one or more processors are configured to cause the first UE to attempt to descramble, with the identifier associated with the first UE, a plurality of cyclic redundancy checks in the second DCI that are each associated with one of the plurality of sets of control information, wherein the identifier comprises a UE-specific identifier of the first UE; and
the one or more processors are further configured to cause the first UE to identify one or more sets of control information, from the plurality of sets of control information, that comprise control information for the first UE in response to successfully descrambling one or more cyclic redundancy checks associated with the one or more sets of control information using the UE-specific identifier of the first UE.

6. The apparatus of claim 3, wherein:
to attempt to decode at least the portion of the second DCI, the one or more processors are configured to cause the first UE to decode a header of the second DCI, the header indicating one of the one or more UEs associated with each subset of the plurality of sets of control information; and
the one or more processors are further configured to cause the first UE to identify one or more sets of control information, from the plurality of sets of control information, that comprise control information for the first UE based at least in part on the header of the second DCI indicating that the one or more sets of control information are associated with the first UE.

7. The apparatus of claim 3, wherein the one or more processors are further configured to cause the first UE to:
decode a field in the first DCI that indicates one of the one or more UEs associated with each subset of the plurality of sets of control information; and
identify one or more sets of control information in the second DCI, from the plurality of sets of control information, that comprise control information for the first UE based at least in part on the field in the first DCI indicating that the one or more sets of control information are associated with the first UE.

8. The apparatus of claim 3, wherein the identifier comprises at least a portion of a UE-specific radio network temporary identifier (RNTI), a broadcast RNTI, a multicast RNTI, or a group RNTI configured by the network node.

9. The apparatus of claim 1, wherein the one or more processors are further configured to cause the first UE to:
refrain from attempting to decode at least the portion of the second DCI to obtain control information for the first UE based at least in part on the one or more UEs that have the control information in the second DCI not comprising the first UE.

10. The apparatus of claim 1, wherein the one or more processors, to cause the first UE to receive the indication, are configured to cause the first UE to receive the indication via the PDCCH.

11. The apparatus of claim 10, wherein the indication comprises a plurality of bits that indicate, via a hash algorithm, the one or more UEs that have the control information in the second DCI.

12. The apparatus of claim 10, wherein the first DCI comprises one or more UE identifiers corresponding to the one or more UEs.

13. The apparatus of claim 1, wherein the one or more processors are further configured to cause the first UE to:
decode a header of the second DCI that comprises the indication of the one or more UEs that have the control information in the second DCI,
wherein determining whether to attempt to decode at least the portion of the second DCI is based at least in part on whether the one or more UEs indicated in the header of the second DCI comprise the first UE.

14. The apparatus of claim 13, wherein:
the header of the second DCI comprises one or more UE identifiers corresponding to the one or more UEs;
the header of the second DCI indicates, for each of the one or more UEs, PDSCH resources carrying control information for a respective one of the one or more UEs; and
the one or more processors are further configured to cause the first UE to attempt to decode at least the portion of the second DCI carried by the PDSCH resources indicated as carrying the control information for the first UE, based at least in part on the one or more UE identifiers in the header of the second DCI comprising a first UE identifier corresponding to the first UE.

15. The apparatus of claim 13, wherein:
the header of the second DCI comprises a plurality of bits that indicate, via a hash algorithm, the one or more UEs that have the control information in the second DCI;
the second DCI comprises a plurality of sets of control information that are each for one of the one or more UEs; and
the second DCI comprises a plurality of UE identifiers each corresponding to a respective one of the plurality of sets of control information, the one or more UE identifiers indicating, for the respective one of the plurality of sets of control information, one of the one or more UEs that is associated with the respective one of the plurality of sets of control information.

16. A method of wireless communication performed by a first user equipment (UE), comprising:
receiving, from a network node, first downlink control information (DCI) via a physical downlink control channel (PDCCH), the first DCI comprising control information for a plurality of UEs and indicating resources of a physical downlink shared channel (PDSCH) that carry second DCI without carrying a downlink shared channel;
receiving, via the resources of the PDSCH, the second DCI from the network node, the second DCI comprising control information for one or more UEs from the plurality of UEs;
receiving, from the network node, an indication of the one or more UEs that have control information in the second DCI; and
determining whether to attempt to decode at least a portion of the second DCI based at least in part on whether the one or more UEs that have the control information in the second DCI comprise the first UE.

17. The method of claim 16, further comprising:
attempting to decode at least the portion of the second DCI to obtain control information for the first UE based at least in part on the one or more UEs that have the control information in the second DCI comprising the first UE.

18. The method of claim 17, further comprising:
attempting to decode at least the portion of the second DCI based at least in part on an identifier associated with the first UE, the second DCI comprising a plurality of sets of control information that each comprise control information for one of the one or more UEs.

19. The method of claim 18, wherein:
attempting to decode at least the portion of the second DCI comprises descrambling a cyclic redundancy check in the second DCI with the identifier associated with the first UE, wherein the identifier is associated with the plurality of UEs; and
the method further comprises identifying one or more sets of control information, from the plurality of sets of control information, that comprise control information for the first UE based at least in part on the one or more sets of control information comprising a UE-specific identifier of the first UE.

20. A non-transitory computer-readable medium storing a set of instructions for wireless communication, the set of instructions comprising:
one or more instructions that, when executed by one or more processors of a first user equipment (UE), cause the first UE to:
receive, from a network node, first downlink control information (DCI) via a physical downlink control channel (PDCCH), the first DCI comprising control information for a plurality of UEs and indicating resources of a physical downlink shared channel (PDSCH) that carry second DCI without carrying a downlink shared channel;
receive, via the resources of the PDSCH, the second DCI from the network node, the second DCI comprising control information for one or more UEs from the plurality of UEs;
receive, from the network node, an indication of the one or more UEs that have control information in the second DCI; and
determine whether to attempt to decode at least a portion of the second DCI based at least in part on whether the one or more UEs that have the control information in the second DCI comprise the first UE.
